(19) United States
(12) Patent Application Publication
(10) Pub. No.: US 2023/0385132 A1
(43) Pub. Date: Nov. 30, 2023

(54) DESTINATION TOOLKIT FOR DESTINATION ACTIONS

(71) Applicant: Twilio Inc., San Francisco, CA (US)

(72) Inventors: Tyson Winfield Mote, San Francisco, CA (US); Daniel Joseph Lasky, Chattahoochee Hills, GA (US)

(21) Appl. No.: 18/067,360

(22) Filed: Dec. 16, 2022

Related U.S. Application Data
(60) Provisional application No. 63/365,585, filed on May 31, 2022.

(51) Int. Cl. G06F 9/54; G06F 11/34

(52) U.S. Cl. CPC G06F 9/542; G06F 11/3409

(57) ABSTRACT

A method of implementing a destination is disclosed. A definition of the destination is received via an API. The definition includes a definition of an action. The definition of the action represents an interaction with an API associated with the destination. The definition of the action includes one or more definitions of one or more input fields associated with the action. The action is surfaced in a user interface. The surfacing includes presenting a graphical representation of the one or more input fields based on the one or more definitions of the one or more input fields. One or more inputs is received via the graphical representation of the one or more input fields. Event data is routed from one or more data sources to the destination. The routing includes mapping the event data to the destination based on the one or more inputs.

### CROSS-REFERENCE TO RELATED APPLICATIONS

This application claims the benefit of U.S. Provisional Application No. 63/365,585, filed May 31, 2022, entitled “DESTINATION ACTIONS,” which is incorporated by reference herein in its entirety.

### TECHNICAL FIELD

The present application relates generally to the technical field of data analytics and, in one specific example, to collecting, managing, analyzing, transforming, and sending customer data (e.g., in real-time) to tools or applications that are specially configured to analyze the customer data, including marketing, product, and analytics tools, as well as data warehouses.

### BACKGROUND

Stakeholders of an entity, such as a private or public corporation, may benefit from a better understanding of how customers are using its digital properties (or, as referred to herein, “interfaces”), including, for example, its web sites, mobile applications, cloud applications, or processes that run on servers or over-the-top (OTT) devices. Because each type of interface may be based on one or more different technologies, it can be a difficult technical task to track events that happen when a user interacts with each interface. Additionally, because each tool or application that may be used to analyze the captured data may have different formatting requirements, translating the captured data for each of these tools (e.g., in real time) can be technically challenging as well. Time may be better spent using the data rather than focusing on how to collect it and make it suitable for analysis.

### BRIEF DESCRIPTION OF THE DRAWINGS

In the drawings, which are not necessarily drawn to scale, like numerals may describe similar components in different views. Some embodiments are illustrated by way of example, and not limitation, in the figures of the accompanying drawings.

FIG. 1 is a block diagram showing an example networked environment that includes a data management system, according to various embodiments of the present disclosure.

FIG. 2 is a block diagram illustrating example modules of the data processing service(s) of FIG. 1.

FIG. 3 depicts an example administrative user interface.

FIG. 4 depicts an additional example administrative user interface.

FIG. 5 is a block diagram of a high-level view of an example data flow 500 (e.g., from a system perspective).

FIG. 6 is a block diagram of a high-level view of an example data flow 600 (e.g., from a user/customer perspective).

FIG. 7 is a block diagram depicting an example user/customer setup flow.

FIG. 8 is a block diagram depicting an example embodiment of a data plane.

FIG. 9 is a block diagram depicting an example embodiment of a data plane.

FIG. 10A-10C are block diagrams depicting an example database configuration.

FIG. 11 depicts an example of a database table that may be created.

FIG. 12 depicts an example of a database table that may be created.

FIG. 13 is a block diagram illustrating a mobile device, according to an example embodiment.

FIG. 14 is a block diagram of an example computer system on which methodologies and operations described herein may be executed, in accordance with an example embodiment.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A method of sending information from one or more sources to one or more destinations is disclosed. A definition of a destination action is received. The definition of the destination action includes a trigger sub-component and a mapping sub-component. Based on an activation of the trigger, the action is performed. The performing of the action includes sending the information to the one or more destinations. The sending of the information includes sending data from one or more fields at the one or more sources to one or more fields at the destination. The one or more fields from the one or more sources are mapped to the one or more fields at the destination.

The sending of the information may include invoking an API of the destination. The trigger may define one or more condition-based filters to narrow the scope of the trigger. A count of the one or more conditions may have a configurable maximum. The mapping of the one or more fields from the one or more sources to the one or more fields at the destination may be based on input received via a graphical user interface. The trigger may specify one or more of an event type, event name, or event property value. The mapping component may be modifiable in a user interface without using code.

A method of implementing a destination is disclosed. A definition of the destination is received via an API. The definition includes a definition of an action. The definition of the action represents an interaction with an API associated with the destination. The definition of the action includes one or more definitions of one or more input fields associated with the action. The action is surfaced in a user interface. The surfacing includes presenting a graphical representation of the one or more input fields based on the one or more definitions of the one or more input fields. One or more inputs is received via the graphical representation of the one or more input fields. Event data is routed from one or more data sources to the destination. The routing includes mapping the event data to the destination based on the one or more inputs.

The definition of the action may include one or more definitions of one or more steps associated with the action. Each of the one or more steps may be passed a data object that propagates an incoming payload or settings across the one or more steps. The one or more steps may include a performance step. The performance step may be invoked after a payload has been resolved based on a configuration associated with the destination. The performance step may be invoked after a payload has been validated against a data schema associated with the destination. The definition may be developed according to a recommended structure.

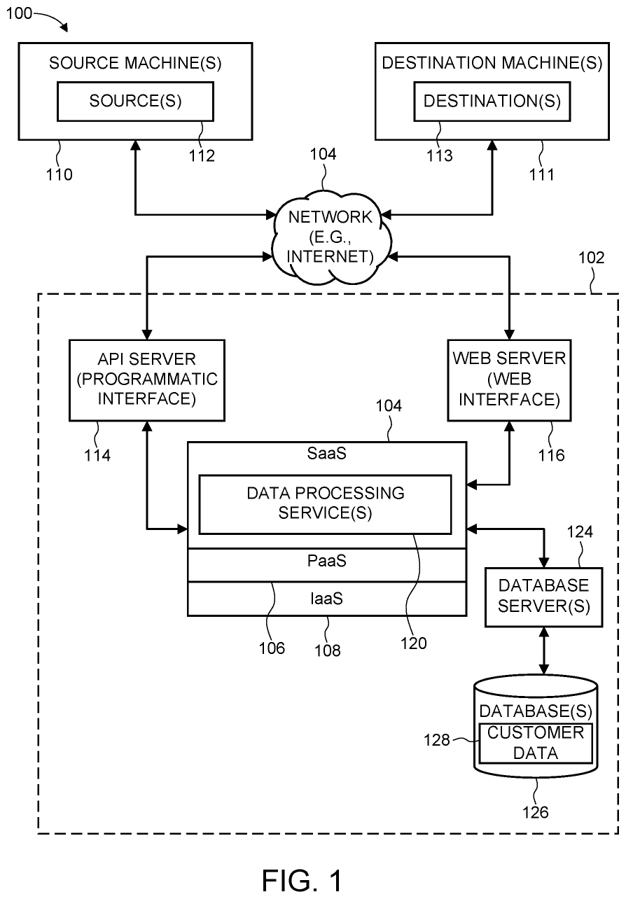

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machine(s) 110 or destination machine(s) 111). The networked system 102 is also referred to herein as “the system” or the “customer data platform (CDP).”

System libraries (e.g., the sources 112) may generate messages about what's happening at an interface, and send them to the system servers (e.g., to the data processing service(s) 120). The system may translate the content of those messages into different formats for use by other tools (e.g., the destinations 113), and send the translated messages to those tools. The system servers may also archive a copy of the data, and/or send data to one or more storage systems (such as databases, warehouses, or bulk-storage buckets).

The source(s) 112 may execute on the source machines 110. Sources may be packaged with interfaces to collect and route data. A source (or more than one) may be created for each website or app that is to be tracked. While it's not required to have a single Source for each server, site or app, it may be recommended to create a Source for each unique source of data.

In example embodiments, Spec methods are used to collect interaction data from interfaces, and Sources are packaged with interfaces to collect and route the data.

Once the system has collected the data (e.g., customer data 128 and/or interaction data), there are several different actions the system may take:
Send it to Destinations, which receive the data from any number of sources (e.g., in real time);
Send it to Warehouses and other bulk storage tools, which may be configured to hold raw event schemas and update on regular intervals;
Enrich the customer data the system collects by connecting data from one or more other tools, and then collect it in a warehouse to monitor performance, inform decision-making processes, and/or create uniquely customized user experiences; and/or
Use an identity resolution tool (e.g., also referred to herein as “Personas”), to unify data from individual users (e.g., to gain a holistic understanding of their actions).

In example embodiments, new sources can be created using a user interface element (e.g., a button) in a workspace view of a user interface presented within an administration application executing on an administration machine (not depicted). Each source may have a write key, which may be used to send data to that source. For example, a client-side analytics library, such as a JavaScript analytics library, may be added to a web page interface by adding a specific code snippet to the web page.

In example embodiments, a mobile SDK may be provided to simplify tracking on client-side mobile applications, such as on iOS, Android, or Xamarin applications.

In example embodiments, a server-side library may be provided for tracking from servers (e.g., when device-mode or client-side tracking is not available or appropriate). In example embodiments, cloud app sources may be provided to pull together data from different third-party tools into a data warehouse or other enabled integrated tools. In example embodiments, there are two types of cloud apps: for object sources and event sources. Object cloud sources can export data from a third-party tool and import it directly into a data warehouse. Event cloud sources can not only export data into a data warehouse, but they can also federate the exported data into other enabled integrations.

In example embodiments, data may be sent directly to a Pixel Tracking API, which may be provided (e.g., for environments where code can't be executed, like environments for tracking email opens). Example events include, for example, the following:

| EVENT NAME | DESCRIPTION |
|---|---|
| Email Delivered | Message has been successfully delivered |
| | to the receiving server |
| Email Opened | Recipient has opened the HTML message. In |
| | example embodiments, Open Tracking must |
| | be enabled for getting this type of event |
| Email Link | Recipient clicked on a link within the message. |
| Clicked | In example embodiments, Click Tracking |
| | must be enabled for getting this type of event |
| Email Bounced | Receiving server could not or would |
| | not accept message |
| Email Marked | Recipient marked message as spam |
| as Spam | |
| Unsubscribe | Recipient clicked on message's subscription |
| | management link |

In example embodiments, a QueryString API may be provided, allowing use of query strings to load API methods (e.g., when a user first visits an enabled interface). This API may be used for tracking events like email clicks and identifying users associated with those clicks on a destination page.

In example embodiments, an HTTP Tracking API may be used to send data directly to a destination (e.g., when none of the other libraries/sources are available or appropriate for an environment).

As mentioned above, Spec methods may be used to collect interaction data from the interfaces. The Spec may provide guidance on meaningful data to capture, and the best formats for it, across libraries and APIs. Implementations that use these formats make it simple to translate data to downstream tools. In example embodiments, the Spec has three components. First, it outlines the semantic definition of the customer data the system captures across all of the system's libraries and APIs. In example embodiments, there are a certain number of API calls in the Spec (e.g., six). They each represent a distinct type of semantic information about a customer. Every call shares the same common fields.

APIs
Identify: who is the customer?
Track: what are they doing?
Page: what web page are they on?
Screen: what app screen are they on?
Group: what account or organization are they part of?
Alias: what was their past or other identity?

Second, it details the event data the system captures across at least some of its cloud sources and destinations.

Cloud Sources and Destinations examples:
Email;
Live Chat; and/or
A/B Testing.

Third, it shares the events that may be recommended to track for a particular industry (e.g., based on analysis of a plurality (e.g., thousands) of customers. Thus, when the Spec is respected, the system can map these events to particular features within end destinations like Google Analytics and Facebook Ads.

Industry Specs examples:
Mobile;
E-Commerce; and/or
Video
B2B SaaS

Source machine(s) 110 may also include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications and file sharing applications. Each of the client applications may include a software application module (e.g., a plug-in, add-in, or macro) that adds a specific service or feature to the application. Any of these client applications may be configured as Sources, as described above.

The system may support several ways to implement tracking. For example, the system may be configured to use device-based or server-based libraries. Device-based libraries, such as JavaScript, iOS, and Android, may be used to make calls on users' browsers or mobile devices. Server-based libraries, such as Node, Python, or PHP, may be used where the calls are triggered on one or more external (e.g., third-party) servers and then sent to the system's servers.

When collecting data using device-based libraries, the system can be configured to execute in at least two different connection modes:

Cloud-mode is where the library sends the data directly to the system's servers which then translate and forward it.

Device-mode is where the library sends the data both directly to the system's servers, and also to the servers for the destination tool. Device-mode may require some additional set-up steps, but can unlock rich device data.

Although there are some tradeoffs between the two approaches, neither is necessarily better than the other, and it may be recommended by the system to implement a mix of both. In general, more direct interaction data is available using a device-based library, but server-based collection is more secure, reliable, and can't be blocked by ad blockers.

In example embodiments, the system defaults to using a cloud-based connection mode (e.g., “cloud-mode”) for any destination connected to a mobile source, because this can help decrease the size of the final app package. When the system is configured to be in cloud-mode, the system sends messages to the system's servers, and then translates and forwards that data on to the downstream tools. This way, an app need only be packaged with the system mobile library.

However, destination tools that specifically deal with mobile interactions may require the system to be configured to use a device-based connection mode (e.g., “device-mode”) so that they can collect information directly on the mobile device.

When should I use Device-mode? When should I use Cloud-mode?

There are two main things to consider when deciding whether to use (e.g., configure the system for) Device- or Cloud-Modes (or both!) for a destination partner.

1. Anonymous Attribution Methodology

Mobile Attribution

The anonymous identifiers used on mobile devices are usually static, which means the system doesn't need to do additional resolution, and the system can build Cloud-mode destinations by default. Because the system uses native advertising identifiers on mobile devices, a full SDK is not needed on the device to reconcile or identify a user. For example, users who viewed an advertisement in one app and installed another app as a result might be tracked.

However, some mobile attribution tools do more advanced reconciliation based on more than the native identifier, which requires the SDK on the device to work properly. For those destinations, the system offers device-mode, which packages the tool's SDK with the system's client-side library, providing the entire range of tool functionality.

Web Attribution

Cross-domain identity resolution for websites requires that the attribution tool use a third-party cookie so it can track a user anonymously across domains. This is a component of attribution modeling. As a matter of principle, the system may only use first-party cookies and may not share cookies with partners, so the system library and the data it collects aren't enough to generate view-through attribution in ad networks.

Customers can load their libraries and pixels in the context of the browser, and trigger requests to attribution providers from their device in response to system API calls to take advantage of advertising and attribution tools.

2. Client-native Destination Features

Some destinations may offer client-side features beyond data collection in their SDKs and libraries, for both mobile and web. In these cases, the system may offer Device-mode SDKs so that the system can collect information on the device using the system, but still get the destination's complete native functionality.

Some features that usually require a Device-mode include automatic A/B testing; displaying user surveys, live chat or in-app notifications; touch/hover heatmapping; and accessing rich device data such as CPU usage, network data, or raised exceptions.

In example embodiments, for destinations that require device-mode, the system-integration version of that tool's SDK may be packaged along with the system's source library in an application. The system's-integration SDK allows collection of data with the system, but also enables device-based features, and still saves space.

When a tool's device-mode SDK is packaged with the system SDK, the system sends the data directly to the tool's API endpoint. The system then also adds the tool to the integrations object and sets it to false, so that the data is not sent a second time from the system's servers.

For example, if the system's SDK is bundled with an Intercom library, the payload might include this:

“integrations”: {
“Intercom”: false
},

In example embodiments, when the system-integration SDKs are packaged with the system, a dependency manager (such as Cocoapods or Gradle) may be used to ensure that all SDKs are compatible and all of their dependencies are included. In example embodiments, the system does not support bundling mobile SDKs without a dependency manager.

When it comes to Mobile SDKs, minimizing size and complexity may be a priority. Therefore, the core Mobile SDKs may be small and offload as much work as possible in handling destinations to the system servers. When this lightweight SDK is installed, access may be granted to the entire suite of server-side destinations.

In example embodiments, certain SDKs may be bundled (instead of just sending data to them from the systems' servers) so that access is provided to their features that require direct client access (e.g., A/B testing, user surveys, touch heatmapping, etc.) or access is provided to device-data such as CPU usage, network data, or uncaught/raised exceptions. For those types of features, the destination's native SDK may be bundled, so that the system can make the most of them.

These lightweight system-tool-SDKs may offer the native functionality of all supported destinations without having to include hefty third-party SDKs by default. This gives control over size and helps prevent method bloat.

The system's libraries may generate messages about what happens on an interface, translate those messages into different formats for use by destinations, and transmit the messages to those tools.

There are several tracking API methods that may be called to generate messages. Examples include the following:
Identify: Who is the user?
Page and Screen: What web page or app screen are they on?
Track: What are they doing?

In example embodiments, every call (or a subset of every call) shares the same common fields. Thus, when these methods are used, it may allow the system to detect a specific type of data and correctly translate it to send it on to downstream destinations.

In example embodiments, the system maintains a catalog of destinations where data can be sent.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., engagement service(s)) 120 are shown in FIG. 1 to form part of the networked system 102, in alternative embodiments, the applications 120 may form part of a service that is separate and distinct from the networked system 102.

Further, while the system 100 shown in FIG. 1 employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although FIG. 1 depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express) or destination systems.

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more analytics, promotional, marketplace or payment functions that are integrated into or supported by relevant applications of the networked system 102.

The server applications 120 may be hosted on dedicated or shared server machines (not shown) that are communicatively coupled to enable communications between server machines. The server applications 120 themselves are communicatively coupled (e.g., via appropriate interfaces) to each other and to various data sources and/or destinations, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as customer data 128. In example embodiments, the customer data includes associated metadata, as described herein.

Navigation of the networked system 102 may be facilitated by one or more navigation applications. For example, a search application (as an example of a navigation application) may enable keyword searches of data items included in the one or more database(s) 126 associated with the networked system 102. Various other navigation applications may be provided to supplement the search and browsing applications.

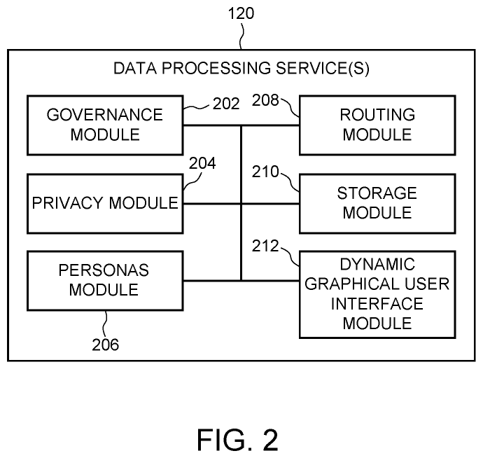

FIG. 2 is a block diagram illustrating example modules of the data processing service(s) 120, which may be configured to provide features to help an entity do more with its data and keep the data clean, consistent, and/or respectful of end-user privacy. A routing (or “connections”) 208 module is configured to handle message routing, as described herein. A privacy module 204 is configured to inspect incoming messages to identify PH, classify it by its riskiness, and decide how it's handled and which tool may use it, as described herein. A governance (or “Protocols” module 202 is configured to create a unified schema for some or all the data the system collects, coordinate implementation to keep it consistent with that schema, and/or make sure the data arrives in the right format (and block and alert when it doesn't), as described herein. A personas module 26 is configured to identify groups of users (“audiences”) based on behavior or other metrics calculated from the data, and send these groups to destinations (e.g., perform identity resolution), as described herein. A storage module 210 may be configured to archive a copy of the data, and/or send data to one or more storage systems, such as databases, warehouses, or bulk-storage buckets.

The system's libraries may generate and send messages to the system's tracking API (e.g., in JSON format), and provide a standard structure for the basic API calls. The system may also provide a recommended structure (also known as a schema, or ‘Spec’) that helps keep the most important parts of the data consistent, while allowing great flexibility in what other information is collected and where.

In example embodiments, there are one or more calls in the basic tracking API, which answer specific questions, such as:
Identify: Who is the user?
Track: What are they doing?
Page: What web page are they on?
Screen: What app screen are they on?
Group: What account or organization are they part of?
Alias: What was their past identity?

Among these calls, Identify, Group, and Alias can be thought of as similar types of calls, all to do with updating our understanding of the user who is triggering system messages. These calls can be thought of as adding information to, or updating an object record in a database. Objects are described using “traits”, which can be collected as part of the calls.

The other three, Track, Page, and Screen, can be considered as increasingly specific types of events. Events can occur multiple times, but generate separate records which append to a list, instead of being updated over time.

A Track call is the most basic type of call and can represent any type of event. Page and Screen are similar and are triggered by a user viewing a page or screen, however Page calls can come from both web and mobile-web views, while Screen calls only occur on mobile devices. Because of the difference in platform, the context information collected is very different between the two types of calls.

Anatomy of a System Message

In example embodiments, the most basic system message requires only a userID or anonymousID; all other fields are optional to allow for maximum flexibility. However, a normal system message has three main parts: the common fields, the context object, and the properties (if it's an event) or traits (if it's an object).

The common fields include information specific to how the call was generated, like the timestamp and library name and version. The fields in the context object are usually generated by the library, and include information about the environment in which the call was generated: page path, user agent, OS, locale settings, etc. The properties and traits are optional and are where the information to be collected can be customized for a specific implementation.

Another common part of a system message is the integration object, which can be used to explicitly filter which destinations the call is forwarded to. However this object is optional, and is often omitted in favor of non-code based filtering options.

Identify calls
analytics.identify( user_id: “12345abcde”,
traits: {
email: ‘michael.phillips@segmant.com”,
name: ‘Michael Phillips’,
city: ‘New York’,
state: ‘NY’,
internal: True }}

The identify call allows system to know who is triggering an event.

When to Call Identify

Call identify when the user first provides identifying information about themselves (usually during log in), or when a they update their profile information.

When called as part of the login experience, identify should be called as soon as possible after the user logs in. When possible, follow the identify call with a track event that records what caused the user to be identified.

When an identify call is made as part of a profile update, only the changed information needs to be sent to the system. All profile info on every identify call can be sent if that makes implementation easier, but this is optional.

Traits in Identify Calls

These are called “Traits” for Identify calls, and “Properties” for all other methods.

The most important trait to pass as part of the identify( ) call is userId, which uniquely identifies a user across all applications.

A hash value can be used to ensure uniqueness, although other values are acceptable; for example, email address isn't the best thing to use as a userid, but is usually acceptable since it will be unique, and doesn't change often.

Beyond that, the Identify call is an opportunity to provide information about the user that can be used for future reporting, so any fields that to be reported on later can be sent.

Consider using Identify and traits when:
Gathering user profile data (for example, company, city/state, job title, or other user-level data) and/or when:
Gathering company-level data (for example, company size, number of seats, etc.)

How to Call Identify

Identify can be called from any of the system's device-based or server-based libraries, including JavaScript, iOS, Android, Ruby, and Python.

Here is an example of calling identify from a library:

analytics.identify(“12345abcde”, {
“email”: “michael.phillips@segment.com”,
“name”: “Michael Phillips”,
“city”: “New York”,
“state”: “NY”,
“internal”: True
));

Using analytics.reset( )

When a user explicitly signs out of an application, the application can call analytics.reset( ) to stop logging further event activity to that user, and create a new anonymousId for subsequent activity (until the user logins in again and is subsequently identify-ed). This call is most relevant for client-side system libraries, as it clears cookies in the user's browser.

Make a Reset( ) call as soon as possible after sign-out occurs, and only after it succeeds (not immediately when the user clicks sign out).

Page and Screen

The Page and screen calls tell the system what web page or mobile screen the user is on. This call automatically captures important context traits, so it is not necessary to manually implement and send this data.

| PAGE CONTEXT | SCREEN CONTEXT | | |
|---|---|---|---|
| AUTO-CAPTURED | AUTO-CAPTURED | | |
| Title | window.location.title | app | build, name, |
| | | | namespace, version |
| url | window.location.url | device | adTrackingEnabled, |
| | | | advertisingId |
| | | | (IDFA/AAID), |
| | | | device ID, manufacturer, |
| | | | model, type (android/ios) |
| path | window.location.path | library | name, version |
| referrer | window.document.referrer | locale | window.document.referrer |
| search | window.location.search | network | cellular, wifi |
| ip | address | ip | address |
| userAgent | string | os | name, version |
| campaign | utm_source, utm_medium, | screen | height, width |
| | utm_campaign, utm_content | | |

Page and Screen Call Properties

The auto-collected Page/Screen properties can be overridden with custom properties and additional custom page or screen properties may be set.

Some downstream tools (like Marketo) may require attachment specific properties (like email address) to every page call.

This is considered a destination-specific implementation nuance. The system may maintain a list of these nuances for each implementation.

Named Page & Screen Calls

A page “Name” may be specified at the start of the page or screen call, which is especially useful to make list of page names into something more succinct for analytics. For example, on an ecommerce site an application might want to call analytics.page(“Product”) and then provide properties for that product:

```
analytics.page(″Product″, {
  ″category″: ″Smartwatches″.
  ″sku″: ″13d31″
});
```

When to Call Page

The system automatically calls a page event whenever a web page loads. This might be enough for most application needs, but if an application changes the URL path without reloading the page, for example in single page web apps, the application must call page manually.

If the presentation of user interface components don't substantially change the user's context (for example, if a menu is displayed, search results are sorted/filtered, or an information panel is displayed on the exiting UI), the event may be measured with a Track call, not a Page call.

When to Call Screen

The system Screen calls are essentially the Page method, except for mobile apps. Mobile Screen calls are treated similarly to standard Page tracking, only they contain more context traits about the device. The goal is to have as much consistency between web and mobile as is feasible.

Track Calls

The Track call allows the system to know what the user is doing.

When to Call Track

The Track call is used to track user and system events, such as, for example:

The user interacting with a UI component (for example, “Button Clicked”); and/or

A significant UI component appearing, other than a page (for example, search results or a payment dialog).

Events and Properties

Track calls should include both events and properties. Events are the actions to track, and properties are the data about the event that are sent with each event.

Properties are powerful. They enable users to capture as much context about the event as they would like, and then cross-tabulate or filter their downstream tools. For example, let's say an eLearning website is tracking whenever a user bookmarks an educational article on a page. Here's what a robust analytics.js Track call could look like:

```
analytics.track (′Article Bookmarked′, {
  ″title″: ′How to Create a Tracking Plan′,
  ″course″: ′Intro to Data Strategy′,
  ″author″: ′Dr. Anna Lytics′,
  ″publish_year″: ′2019′,
  ″publish_month″: ′03′,
  ″length″: ′Medium - 1000-2000 words′,
  ″assets″: {′Infographics′,′Interactive Charts′},
  ″topics″: {′Data Planning′,′Segment′,′Data Flow′},
  ″button_location″: ′Subheader - 3rd Column′
});
```

With this track call, the system can analyze which authors had the most popular articles, which months and years led to the greatest volume of bookmarking overall, which button locations drive the most bookmark clicks, or which users gravitate towards infographics related to Data Planning.

Event Naming Best Practices

Each event tracked should have a name that describes the event, like ‘Article Bookmarked’ above. That name is passed in at the beginning of the track call, and should be standardized across application properties so the same actions can be compared on different properties.

In example embodiments, a best practice may be to use an “Object Action” (Noun< >Verb) naming convention for all Track events, for example, ‘Article Bookmarked’.

The system maintains a set of Business Specs which follow this naming convention around different use cases such as eCommerce, B2B SaaS, and Mobile.

Let's dive deeper into the Object Action syntax that all system Track events should use.

Objects are Nouns

Nouns are the entities or objects that the user or the system acts upon.

Some Suggested Nouns
Menu;
Navigation Drawer (the “Hamburger” menu in the upper left corner of a UI);
Profile;
Account; and/or
Video.

Actions are Verbs

Verbs indicate the action taken by a user on a site. When an application names a new track event, consider if the current interaction can be described using a verb from the list below.

Otherwise, a verb may be chosen that describes what the user is trying to do in a specific case, but that is flexible enough so that it could be used in other scenarios.

Some Suggested Verbs
Applied—Applying a new format to the UI results;
Clicked—Catch-all for events where a user activated some part of the UI but no other verb captures the intent;
Created/Deleted—The user- or system-initiated action of creating or deleting an object (e.g., new search, favorite, post);
Displayed/Hidden—The user- or system-initiated action of hiding or displaying an element;
Enabled/Disabled—Enabling or disabling some feature (e.g., audible alarms, emails, etc);
Refreshed—When a set of search results is refreshed;
Searched—When an app is searched;
Selected—User clicked on an individual search result;
Sorted—The user or UI action that causes data in a table, for example, to be sorted;
Unposted—Making a previously publicly-viewable posting private;
Updated—The user action that initiates an update to an object (profile, password, search, etc.; typically be making a call to the backend), or the they system having actually completed the update (often this tracking call will be made in response to a server-side response indicating that the object was updated, which may or may not have an impact on the UI); and/or
Viewed—(exactly what it says on the tin).

Property Naming Best Practices

The system may recommend recording property names using snake case (for example property_name), and that property values be formatted to match how they are captured. For example, a username value would be captured in whatever case the user typed it in as.

Common Properties to Send with Track Call

The following properties should be sent with every Track call:

| EVENT CONTEXT | PROPERTY NAME | DESCRIPTION |
|---|---|---|
| Any Track call | initiator | States whether the event |
| | | was initiated by the user or |
| | | the system. |
| Any Track call | display_format | Responsive or not (or some |
| | | other indicator of the |
| | | current page layout |
| | | template) |
| Search | [Search Parameters] | All search parameters, with |
| Initiated or | | the names being the snake |
| Search | | case version of the internal |
| Results | | names. |
| Displayed | | |
| Search | total_result_count | The total number of results |
| Results | | returned that match the |
| Displayed | | search parameters. This |
| | | number represents the |
| | | number of results that could |
| | | be returned to the user even |
| | | if only a subset of those |
| | | were actually returned (for |
| | | example, if the results are |
| | | paginated). |
| Paginated List | total_items_pages | The total number of pages |
| Displayed | | of items available to be |
| | | viewed by the user. |
| Paginated List | items_per_page | The number of possible |
| Displayed | | items in each page of items |
| | | (for example, if the Ul is |
| | | showing 50 search results |
| | | per page). The actual |
| | | number of items in the |
| | | current page may be less |
| | | than this number if, for |
| | | example, the system is |
| | | displaying the last page of |
| | | results and there aren't |
| | | enough results to fill to the |
| | | page's maximum (for |
| | | example, if there are 27 |
| | | results when the page could |
| | | display as many as 50). |
| Paginated List | current_item_page | The current page number |
| Displayed | | displayed to the user. |
| External Link | destination_url | The URL that the user is |
| Clicked | | taken to when clicked. |
| | | Ideally, this will be the final |
| | | destination (for example, |
| | | after any redirects), but only |
| | | the immediate destination is |
| | | likely in most cases. |
| Item List | sort_column | The internal name of the |
| Sorted | | column that was sorted. |
| Item List | sort_direction | Whether the items sort in |
| Sorted | | ascending or descending |
| | | order. |

How to Call Track

Track can be called from any of system's client-side or server-side libraries, including Javascript, iOS, Android, Ruby, and Python. Here is an example of calling track from a library:

```
analytics.track(′Article Bookmarked′, {
  ″title″: ′How to Create a Tracking Plan′,
  ″course″: ′Intro to Data Strategy′,
  ″author″: ′Dr. Anna Lytics′,
});
```

The system's libraries may generate and send messages to a tracking API (e.g., in JSON format). A standard structure for the basic API calls may be provided, along with a recommended structure (also known as the ‘Spec’, a type of schema) that helps keep the most important parts of a set of data consistent, while allowing great flexibility in what other information is collected and where.

Messages

When implementing the system, developers add system code to their website, app, or server, which generates messages based on specific triggers the developer defines. In simple form, this code can be a snippet that the developer copies and pastes into the HTML of a website to track page views. It can also be as complex as system calls embedded in a mobile app to send messages when the app is opened or closed, when the user performs different actions, or when time based conditions are met (for example “ticket reservation expired” or “cart abandoned after 2 hours”).

The system has Sources and Destinations. Sources send messages into the system (and other tools), while Destinations receive messages from the system.

Anatomy of a System Message

The most basic system message requires only a userID or anonymousID; all other fields are optional to allow for maximum flexibility. However, a normal system message has three main parts: the common fields, the “context” object, and the properties (if it's an event) or traits (if it's an object).

The common fields include information specific to how the call was generated, like the timestamp and library name and version. The fields in the context object are usually generated by the library, and include information about the environment in which the call was generated: page path, user agent, OS, locale settings, etc. The properties and traits are optional and are where developers customize the information they want to collect for their implementation.

Another common part of a system message may be an integrations object, which developers can use to explicitly filter which destinations the call is forwarded to. However this object is optional, and may be omitted in favor of non-code based filtering options.

Sources

The system provides several types of Sources which developers can use to collect their data, and which developers can choose among based on the needs of their app or site. For websites, developers can embed a library which loads on the page to create the system messages. If developers have a mobile app, developers can embed one of our Mobile libraries, and if developers would like to create messages directly on a server (if they have, for example a dedicated .NET server that processes payments), the system provides several server-based libraries that developers can embed directly into their backend code. (Developers can also use cloud-sources to import data about their app or site from other tools like Zendesk or Salesforce, to enrich the data sent through the system.)

Destinations

Once the system generates the messages, it can send them directly to the system's servers for translation and forwarding on to the Destinations being used, or it can make calls directly from the app or site to the APIs of the Destination tools. Which of these methods to choose depends on which Destinations are being used and other factors, as described in more detail below.

What Happens Next?

Messages sent to the system's servers using the tracking API can then be translated and forwarded on to Destination tools, inspected to make sure that they're in the correct format or schema, inspected to make sure they don't contain any Personally Identifying Information (PH), aggregated to illustrate overall performance or metrics, and archived for later analysis and reuse.

A workspace is a group of sources that can be administered and billed together. Workspaces help companies manage access for multiple users and data sources. Workspaces let users collaborate with team members, add permissions, and share sources across their whole team using a shared billing account.

When a developer first logs in to their system account, they can create a new workspace, or choose to log into an existing workspace if the developer's account is part of an existing organization.

Sources belong to a workspace, and the URL for a source may look something like this: https://segment.com/<my-workspace>/sources/<my-source-name>/

Destinations include business tools or apps that developers can connect to the data flowing through the system. Example of destinations include Google Analytics, Mixpanel, Kissmetrics, Customer.io, Intercom, and KeenIO.

All of these tools may run on the same data: who are the customers and what are they doing? But each tool requires that data be sent in a slightly different format, which means that developers have to write code to track all of this information, again and again, for each tool, on each page of an app or website.

The system eliminates this process by introducing an abstraction layer. Developers send their data to the system, and the system understands how to translate it so the system can send it along to any destination. Developers enable destinations from a catalog in the system, and user data immediately starts flowing into those tools.

The system may support many categories of destinations, from advertising to marketing, email to customer support, CRM to user testing, and even data warehouses. Developers can view a complete list of our destinations or check out our destination within the administration system user interface for a searchable list broken down by category.

A warehouse is a central repository of data collected from one or more sources. This is what commonly comes to mind when developers think about a relational database: structured data that fits neatly into rows and columns.

With respect to the system, a Warehouse is a special type of destination. The system may stream data to the destination all the time or the system may load data in bulk at regular intervals. When the system streams or loads data, the system insert and update events and objects, and automatically adjust their schema to fit the data developers have sent to the system.

A Warehouse may also be a special type of source; for example, in a warehouse may be a source in a Reverse ETL implementation.

Routing Data to Destinations

When developers enable a destination in the system (e.g., via the system's administration user interface), they link it to a specific source (or sources). By default, the system first processes the data from the selected source(s), then translates it and routes it from the system's servers to the API endpoint for that destination.

This means that if developers previously had loaded code or a snippet for that tool on their website or app, they should remove it once they have the system implemented so they don't send duplicate data.

Developers might also want to enable tools that need to be loaded on the user's device (either a computer or mobile device) in order to function properly. For our system library, developers can make these changes from the administration user interface, and the system then updates the bundle of code served when users request the page to include code required by the destination.

Adding New Destinations

Adding a destination is quick and easy from the system's administrative user interface. Developers may need a token or API key for the tool, or some way to confirm their account in the tool.

From the system workspace, click Add destination. In example embodiments, this option can be found on the Connections home page of the user interface, from the Destinations list, or from a Source overview page.

Search for the destination in the Catalog, and click the destination's tile.

From the destination summary page that appears, click Configure.

Choose which source should send data to this destination, and click Confirm source.

In the Connection Settings that appear, enter any required fields. These might be an API key, an account ID, a token; otherwise, a log in prompt might appear.

If needed, click the toggle to enable the destination so it begins receiving data.

Recommended Destinations

How to choose from all of the available destinations?

As a start, the system may recommend that to have one tool from each of the following categories:
Analytics
Email marketing
Live-chat

If a developer is adding more destinations after they have done their system instrumentation, they might want to check that the destinations they choose can accept the methods already being used, and that the destinations can use the Connection Modes already being used.

Adding a Warehouse

Warehouses are a special type of destination which receive streaming data from system sources and store it in a table schema based on system calls. This allows developers to do a lot of interesting analytics work to answer their own questions about what their users are doing and why.

Developer may spend a bit of time considering the benefits and tradeoffs of the warehouse options, and then choose one from the warehouse catalog.

When developers choose a warehouse, they can then use the steps in the administrative user interface to connect it. This may require that they create a new dedicated user (or “service user”) to allow the system to access the database.

Once a warehouse is configured and running, developers can connect to it using a Business Intelligence (BI) tool (such as Looker, Mode, Tableau, or others) to analyze their data in-depth.

There are also a number of Business tier features developers can then use with their warehouse, including selective sync and Replay.

Destination Actions

The system's Destination Actions framework improves on classic destinations by enabling developers to see and control how the system sends the event data it receives from their sources, to actions-based destinations. Each Action in a destination lists the event data it requires, and the event data that is optional.

Developers can also choose which event types, event names, or event property values trigger an Action. These triggers and mappings make it possible to send different versions of the Action, depending on the context from which it is triggered.

Each Actions-framework Destination seen in the system catalog (e.g., via the administrative user interface) represents a feature or capability of the destination which can consume data from a system source. The Action lists which data from the events it requires, and which data is optional. For example, Amplitude requires that a LogEvent is always sent, and Slack always requires a PostMessage. Each Action also includes a default mapping which developers can modify.

Benefits of Destination Actions
Easier setup: Users see fewer initial settings which can decrease the time spent configuring the destination.
Increased transparency: Users can see the exact data that is sent to the destination, and when the system sends it. For example, users can see exactly when the system sends an IP address to FullStory or an AnonymousId to Amplitude.
Improved customization: Users can determine how the events their sources trigger and map to actions supported by the destination. For example, define the exact events that are considered to be purchases by a particular destination, such as Braze.
Partner ownership: Partners can own and contribute to any Actions-based destination that use cloud and/or device mode (web).
Support for new sources: Enables the system to support destinations for new kinds of sources that may or may not follow a particular or predefined data schema. For example, the system supports implementing Reverse ETL such that customers can load data from their data warehouse into Action Destinations without major changes because the system is agnostic to the input data schema.

Destination Actions Compatibility

Destination Actions do not require that developers disable or change existing (e.g., classic) destinations. However, to prevent data duplication in the destination tool, developers should make sure they aren't sending the data through both a classic destination and the Actions destination at the same time.

Developers can still use an Event Tester with Destination Actions, and event delivery metrics are still collected and available in the destination information pages.

If developers are using Protocols, Destination Actions actions are applied after schema filters and transformations. If developers are using destination filters, Actions are applied after the filters—meaning that they are not applied to data that is filtered out.

Components of a Destination Action

A Destination Action contains a hierarchy of components, that work together to ensure the right data is sent to the destination.

| COMPONENT | DESCRIPTION |
|---|---|
| Global | Define authentication and connection-related |
| Settings | information like API and Secret keys. |
| Mappings | Handle the individual calls to the destination. |
| | In them, developers define what type of call |
| | they want to make to the destination, and what |
| | triggers that call. Individual Destination Actions |
| | may come enabled with some predefined mappings |
| | to handle common events like Screen calls, |
| | Identify calls, and Track calls. Mappings |
| | have two components that make this |
| | possible: Triggers and an Action. |
| Triggers | Enable developers to define when the |
| | corresponding Action fires. As part of a |
| | Trigger, developers can use condition-based |
| | filters to narrow the scope of the trigger. |
| | In example embodiments, self-service users can |
| | add a particular configurable maximum |
| | (e.g., two conditions) per trigger. |
| Actions | Determine the information sent to the destination. |
| | In the Configure action section, developers map |
| | the fields that come from their source(s), to fields |
| | that the destination expects to find. Fields on |
| | the destination side depend on the type of |
| | action selected. |

For example, in the Amplitude (Actions) destination, a user (e.g., an administrator) may define API and Secret keys in the destination's global settings. Then, the provided Page Calls mapping:
Triggers the action on all incoming Page events; and/or
Runs the Log Event action, to map incoming data to Amplitudes properties.

Set Up a Destination Action

To set up a new Actions-framework destination for the first time (e.g., using an example administrative user interface):
Log in to the Workspace where developers want to add the new destination, go to the Catalog page, and click the Destinations tab. (Developers can also get to this screen by clicking Add Destination either from an existing Source, or from their list of existing destinations.)
Click the Destination Actions category in the left navigation, then click the destination to add.
From the preview screen that appears, click Configure.
If prompted, select the source to connect to the new destination.
Enter credentials. This could be an API Key and secret key, or similar information that allows the destination to connect to an account.
Next, choose how to set up the destination, and click Configure Actions. For example, choose Quick Setup to use the default mappings, or choose Customized Setup (if available) to create new mappings and conditions from a blank state. Developers can edit these mappings later.
Once satisfied with the mappings, click Create Destination
Migrate an existing (e.g., “classic”) destination to an actions-based destination
Moving from a classic destination to an actions-based destination may involve a procedure like this:
Create the actions-based destination with a development or test source.
Copy API keys, connection details, and other settings from the classic destination to the actions-based destination.
Migrate specific settings for the actions-based destination according to any specific requirements of the actions-based destination.
Disable the classic version of the destination, and enable the actions-based version.
Verify that data is flowing from the development or test source to the partner tool.
Repeat the steps above with a production source.

Edit a Destination Action

Developers can add or remove, disable and re-enable, and rename individual actions from the Actions tab on the destination's information page in the administrative user interface. For example, click an individual action to edit it.

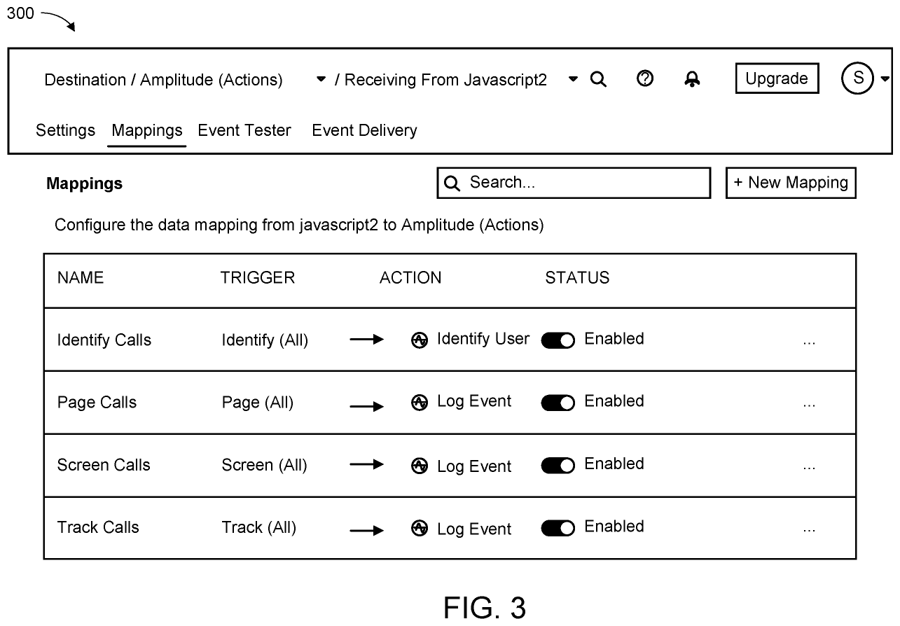

FIG. 3 depicts an example administrative user interface 300. From the edit screen, a user (e.g., an administrator) can change the action's name and mapping, and toggle it on or off.

Disable a Destination Action

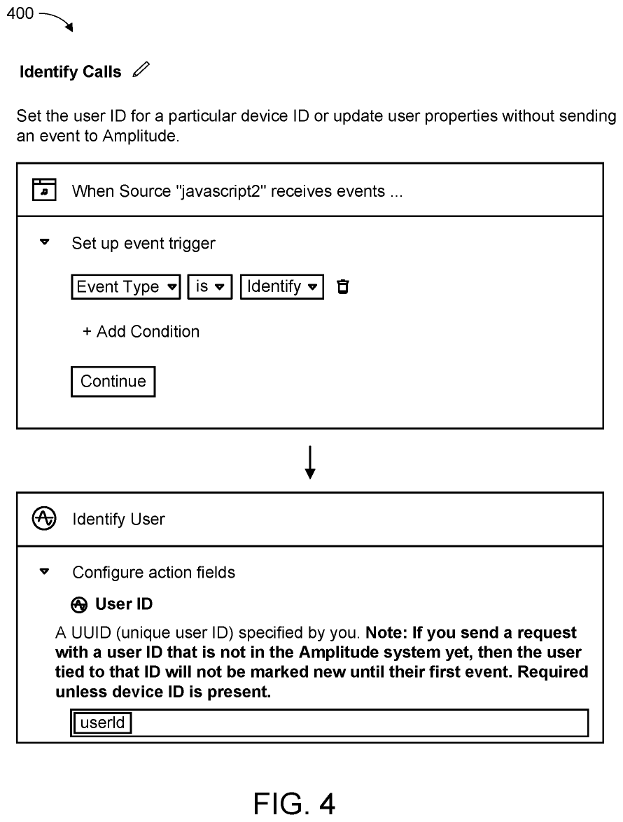

FIG. 4 depicts an additional example administrative user interface 400. If a user wants to stop an action from running, but doesn't want to delete it completely, the user can click the action to select it, then click the toggle next to the action's name to disable it. This takes effect quickly (e.g., substantially immediately or within seconds or minutes), and disables the action until the user reenable it.

Delete a Destination Action

To delete a destination action: click the action to select it, and click Delete (the trash can icon).

This takes effect quickly (e.g., substantially immediately), and removes the action completely. Any data that would have gone to the destination is not delivered. Once deleted, the saved action cannot be restored.

Customizing Mappings

If a user is using the default mappings for a destination action, the user does not need to customize the mapping template for the action. However, the user can edit the fields later if the user finds that the defaults no longer meet the user's needs.

To create a custom destination action, start from the Actions tab. If necessary, click New Mapping to create a new, blank action.

In the edit panel, define the conditions under which the action should run.

Test those conditions to make sure that they correctly match an expected event. This step looks for events that match the criteria in the debugger queue, so developers might need to trigger some events with the expected criteria to test their conditions. Developers can skip the test step if needed, and re-try it at any time.

Next, set up the data mapping from the system format to the destination tool format.

Test the mapping with data from a sample event. The edit panel shows developers the mapping output in the format for the destination tool. Developers can change their mapping as needed and re-test.

When satisfied with the mapping, click Save.

The required fields for a destination mapping may appear automatically. The user may click a user interface element (e.g., a + sign) to see optional fields.

Conditions

In example embodiments, self-service users can add a configurable maximum number of conditions (e.g., two conditions) per trigger. In example embodiments, trigger/conditions are stored and executed (e.g., as an internally-developed query language for JSON, such as Filter Query Language (FQL). The system's GUI has a translation layer that turns such statements into GUI components that customers can use to create the trigger/conditions in a user-friendly manner.

One or more of the following type filters and operators may be available to help build conditions:
Event type (is/is not). This allows developers to filter by the event types in the system Spec;
Event name (is, is not, contains, does not contain, starts with, ends with). Use these filters to find events that match a specific name, regardless of the event type; and/or
Event property (is, is not, less than, less than or equal to, greater than, greater than or equal to, contains, does not contain, starts with, ends with, exists, does not exist). Use these filters to trigger the action only when an event with a specific property occurs. Developers can specify nested properties using dot notation, for example context.app.name. If the property might appear in more than one format or location, developers can use an ANY statement and add conditions for each of those formats. For example, developers might filter for both context.device.type=ios as well as context.os.name=“iPhone OS” The does not exist operator matches both a null value or a missing property.

Developers can combine criteria in a single group using ALL or ANY. Use an ANY to “subscribe” to multiple conditions. Use ALL when developers need to filter for very specific conditions. In example embodiments, developers can only create one group condition per destination action; developers cannot create nested conditions.

Destination Filters

Destination filters are compatible with Destination Actions. Consider a Destination Filter when:
Developers need to remove properties from the data sent to the destination; and/or
Developers need to filter data from multiple types of call (for example, Track, Page, and identify calls).

If a use case does not match these criteria, the user might benefit from using Mapping-level triggers to match only certain events.

At a high level, users can group the many responsibilities of a Destination into two groups with an important distinction between them:
Preparation: Filtering, annotation, transformation, and mapping of the input event to the fields expected by the partner API; and
Delivery: Formatting and delivery of payload to partner API. This includes dealing with partner weirdness like odd formatting requirements, improper error handling, rate limits, authentication headers, and so on.

A distinction between the two groups is that, in an ideal world, the user (e.g., customer) has ownership and control of Preparation and the system has ownership and control of Delivery. In the ideal world, customers can easily configure a destination to behave the way that they want without worrying about all the partner-specific implementation details because the system provides that value for them by providing a stable, clean schema to target while handling the messy work of actually delivering that data to the partner.

In example embodiments, classic Destinations provide no transparency and little customization of how events get transformed and sent downstream to partner tools. For example, these mappings are hard-coded and buried in private GitHub repos.

The Destination Actions framework outlines a new approach to how the system defines Destinations with the goal of solving several problems customers experience by enabling one or more of the following things:
A new subscriptions and actions-based UI that focuses on use cases. This new UI provides tools to create, update, and modify subscriptions and mappings without code. In Destinations Actions, customers are provided with a base set of subscriptions and actions and allow them to create, modify, and delete to satisfy their use cases;
Unlock fully customizable mappings and transformations by providing a UI and standardized transformation DSL to all action-based Destinations. Customers are able to intuitively and flexibly modify how event data is prepared prior to delivery. This customization can be validated against a strongly-typed schema to help guide users with this power; and/or
Significantly reduced Destination maintenance costs. The new Destinations Actions platform is easy and safe to work with such that customer teams can begin to share or even fully take over Destination builds and maintenance.

### Terminology

Destination

A server-side destination. This represents a system integration with a partner tool (e.g., “Slack”).

Action

A discrete behavior between the system and a partner API. Most destinations are comprised of multiple actions. For example, a destination that maps 1:1 with system events might have a Track action, Identify action, Page action, etc. Destinations that have more specific behaviors might have more nuanced actions—SendGrid for example may have an action to Send Email.

Subscription

A customizable query specifying which events should get sent to a specific action. E.g. Send all identify( ) events or Send “Order Completed” with revenue>$100.

Step

A discrete execution step within an action. For example, there may be multiple steps executed when a subscription matches an event, such as: 1) mapping→2) validation→3) performing the action.

Custom [Action|Step]

A customer-defined function that allows developers to extend a destination with behavior not provided out of the box. This could mean writing their own “Post to Channel” action for Slack, or it could mean writing an enrichment step before executing the pre-defined action, e.g., format dates a specific way before piping the data to the “Post to Channel” action.

What the System Sends to Partners is Transparent

Customers can clearly see what data is sent to the partner destination in the UI. They can view default or customized fields for an action. They can view the default or customized subscription that triggers an action.

Fields can be Customized

Customers can customize what data is sent to the partner destination. They can use static values or can pull data from the system event through “mappings.” This includes mappings like text templates (e.g. greeting=“hello,”), and property mappings (e.g. full_name=“$.properties.name”).

Action Subscriptions can be Customized

Customers can modify the subscription that triggers an action.

Actions can be Individually Enabled/Disabled

Customers can turn a fully configured action on or off whenever they want. When a subscribed action is disabled, no events will get delivered to it. Additionally, only valid actions can be enabled (e.g., requiring that all required fields are set, and all values meet the validation criteria).

Plug-n-Play Destinations

Customers are able to start using at least a subset of destinations immediately, without customization, whenever possible. This means the system has several levels of sane/recommended defaults, including one or more of: default actions for a destination, default subscriptions for an action, or default mappings for an action field.

Observability

Customers are provided with insight into how events move through the pipeline, including this new level of granularity: the subscription+action. Another vector is introduced (e.g., action id) so the system can see which action succeeded, failed, rejected, retried, etc.

Internal/Developer Experience

Intuitive to Create Destinations and Actions

Users (e.g., developers) are able to quickly and easily create new destinations, new actions, or make changes to them. A first class user interface (e.g., a command-line interface) is provided as support for scaffolding to reduce boilerplate.

Streamlined Publishing Process

Publishing new destinations, actions, or changes to them is straightforward, safe, and instills confidence.

Type-Safe JavaScript DSL

Writing destination or action definitions provides as much type-safety as possible. The integrated development environment (IDE) and compiler provides guidance, autocompletion, and validation that developers are defining destinations properly.

Best-In-Class Testing Strategy

Testing is not an afterthought. Testing destination actions is easy using helpful testing primitives.

Architecture

In Destinations Actions, a Destination is one or more base settings (API key, URL endpoint, global options—typically authentication-related) and one or more Subscriptions and Actions delivering data to an external partner like Mixpanel, HubSpot, or Salesforce.

A Subscription is an “if” statement that matches incoming events and, when matched, causes the associated Action to be taken. The “if” statement can match all events, a specific type of event (track, identify, etc.), or a more complex statement like, “if track event and traits.email doesn't match ‘*@mycompany.com’”.

An Action is a customer-editable mapping and transformation configuration that maps the customer's input event to a system-defined and system-owned partner action that the customer selects (e.g., “Slack: Post message to channel” or “Mixpanel: Update user”). After mapping the input event to the partner action, the partner action code handles transforming, validating, and delivering the final payload to the partner API.

Each partner action may have a well-formed definition (e.g., JSON Schema) that customers map and transform against. The system then handles taking the well-formed input payload, performing any final transformations (e.g., converting timestamps to Unix timestamps for Intercom, encoding as XML, truncating fields where required, etc.), and delivering the final payload to the partner API. Customers are exposed to as little partner-specific implementation details as possible while still retaining the flexibility that custom mapping and transformations provides.

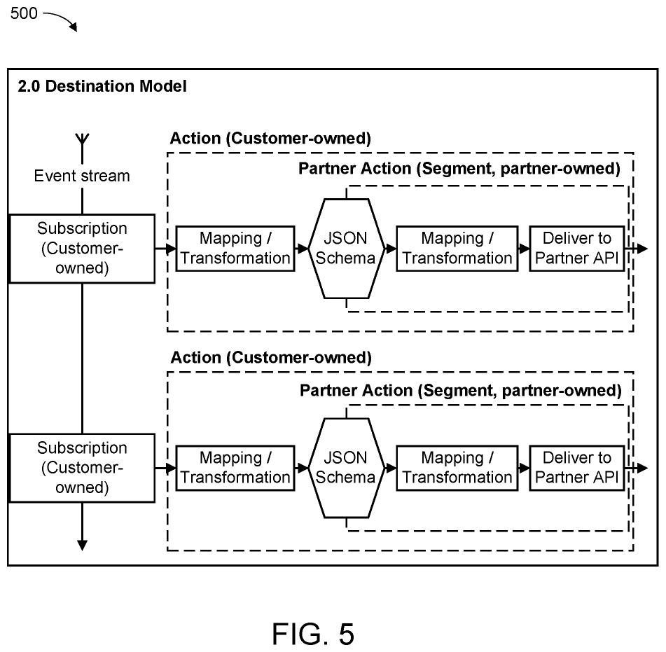

FIG. 5 is a block diagram of a high-level view of an example data flow 500 (e.g., from a system perspective).

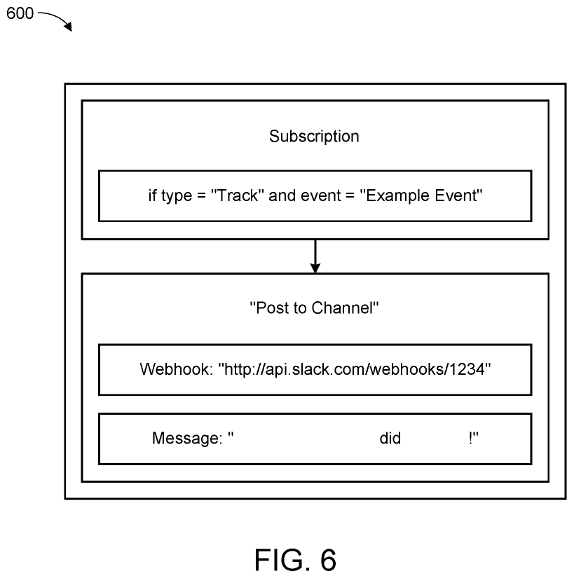

FIG. 6 is a block diagram of a high-level view of an example data flow 600 (e.g., from a user/customer perspective).

When the customer connects a new action-based Destination, it comes with a default set of Subscriptions and Actions that they can enable, disable, and add to. Each individual Action comes with defaults that the customer can leave as-is or modify, as well. After the customer connects a Destination, the system does not automatically add or remove Subscriptions or Actions from that Destination. In other words, the base set of Subscriptions and Actions for a Destination are a template. Changes to the template do not automatically update all Destinations created from the template.

Conversely, partner actions are owned, maintained, and updated by the system. If a customer is using the “Slack: Post message to channel” partner action and the system updates that partner action due to a Slack API deprecation, all customers will get the update so that they don't have to do anything on their end.

Customer Setup Flow

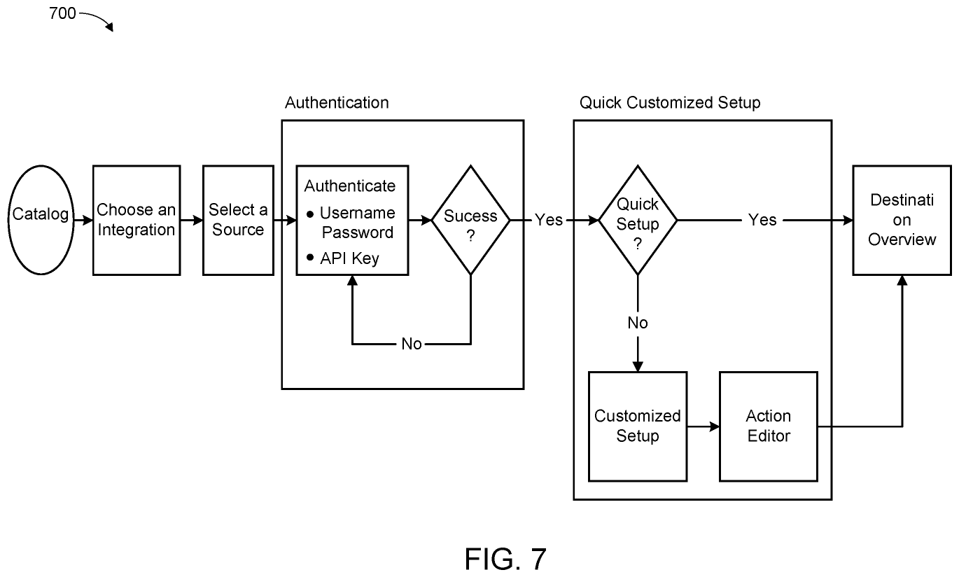

FIG. 7 is a block diagram depicting an example user/customer setup flow.

Customers select action-based destinations when connecting a destination directly to a source, or when browsing the catalog. Before the system creates the new destination, the customer must choose the source and authenticate with the partner API. The authentication flow depends on the authentication scheme defined by the destination—it might be OAuth 2, Bearer, Basic, or Custom (“custom” may be a common scenario: api_key, and maybe other fields like subdomain).

Action-based destinations may define a “test” method that can be used by the UI or an API to programmatically test the customer's authentication against the partner API. For instance, OAuth 2 destinations may use the /me.json user profile endpoint to assert that the authentication tokens are valid and can return information about a person associated with the tokens. The customer need not worry about what's happening under the hood, but will receive feedback in the UI that their authentication was either successful or not. Customers may need to enter successful authentication to continue.

After they've selected a source and have successfully authenticated, the system will create the destination. The customer doesn't need to do anything else at this point for the majority of action destinations. If they want to start customizing the defaults (the pre-defined actions, subscriptions, and mappings) they can.

However, some destinations may not have actions that work out-of-the-box. These destination actions require additional customer input. For instance, Slack only has a “Post to Channel” action that requires a webhook URL.

Customization
Customers can easily customize the behavior of any action that a destination performs, such as, for example:
Subscriptions: Customers can modify the events that trigger an action by changing the subscription;
Mappings: Customers can modify how an event maps to the payload sent to the action (and partner API); and/or
Actions: Customers can enable/disable actions, add actions, and remove actions.

### Data Plane: Embodiment 1

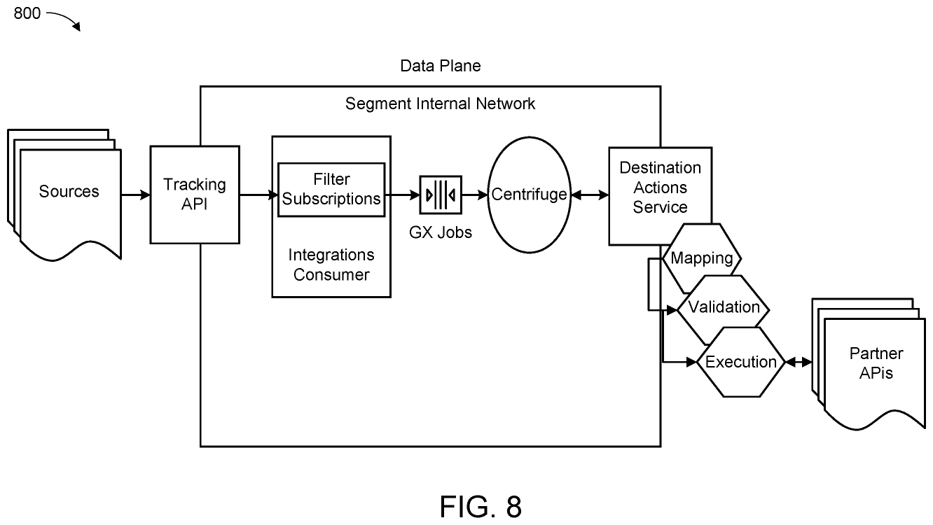

FIG. 8 is a block diagram depicting an example embodiment of a data plane 800. The system may filter subscriptions (e.g., written and evaluated in a language such as Filter Query Language (FQL)) in integrations-consumer. Each matched subscription would produce an equivalent distribution (e.g., “Centrifuge GX”) job including the global destination settings, the matched subscription's action mapping, and the event. This enables features like automatic retry and replay to work properly if some triggered actions succeed while others fail.

All destinations of type action_destination are sent to an engine (e.g., http://fab-5-engine.segment.local/actions/:destinationId) using a Cloud Events plugin and processed in compliance with an integrations specification.

Once the delivery request is received (e.g., by an actions delivery module and/or an integrations service), each event may execute several steps to perform the action, including, for example:

Transform the event using customer-defined mapping (and fall back to default mappings) to the defined shape of the action fields' JSON Schema;

Validate the transformed input against the action fields' JSON Schema; and/or

Perform the action talking to the partner API.

There may be several other considerations during this flow:
Perform any “cached” or “computed” field requests—some fields may be computed from other data or may be resolved asynchronously by fetching some data from another partner API; and/or
Handle automatic authentication steps such as token refresh when encountering an invalid or expired token response.

Note: While not explicitly depicted, each step in the Destination Actions Service may be discrete/decoupled and can be extracted if so desired.

### Data Plane: Embodiment 2

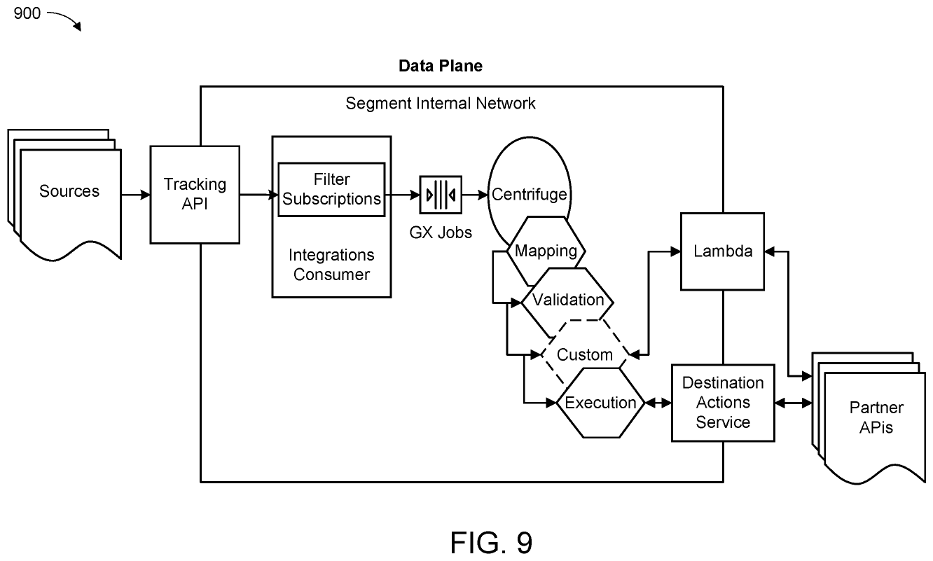

FIG. 9 is a block diagram depicting an example embodiment of a data plane 900.

In various embodiments, the system may lift steps out of the actions module and/or integrations service to be handled as nodes in an execution graph, piping data from one step to the next. This may include lifting mapping, validation, and custom actions into a message distribution system (e.g., Segment's Centrifuge), while keeping the main action code in the actions module and/or integrations service.

Data Model

Destinations may make up several tables in the system's control-plane database (e.g., MySQL database).

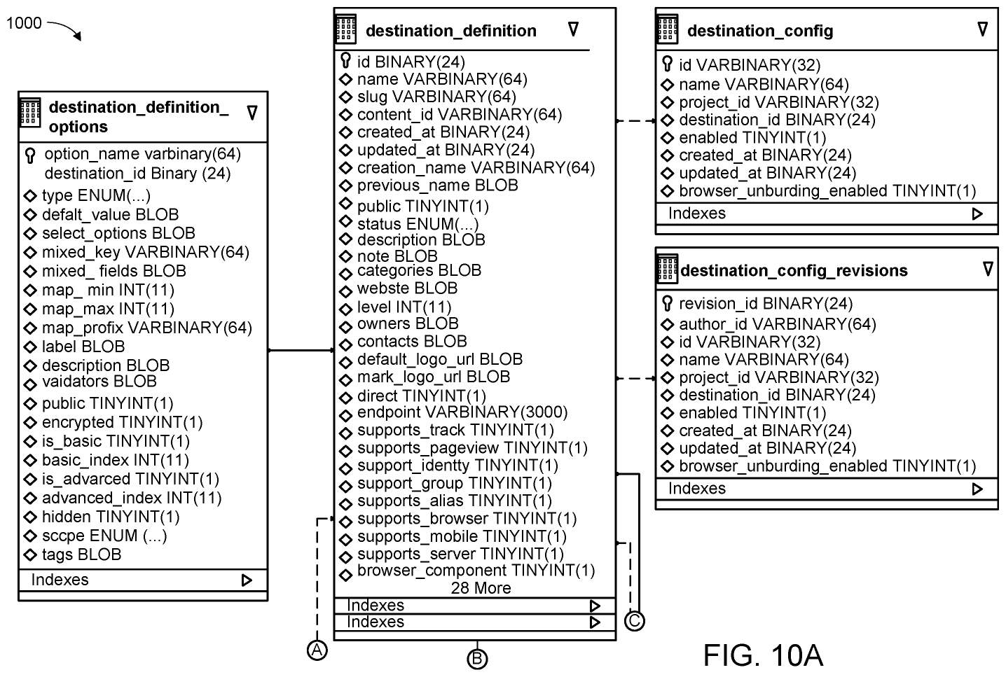

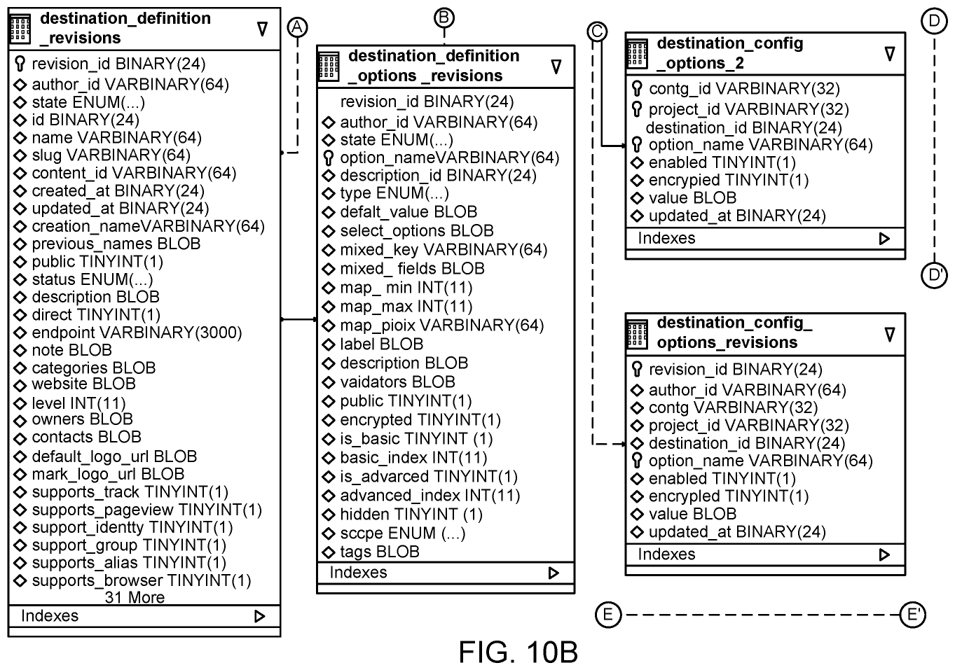

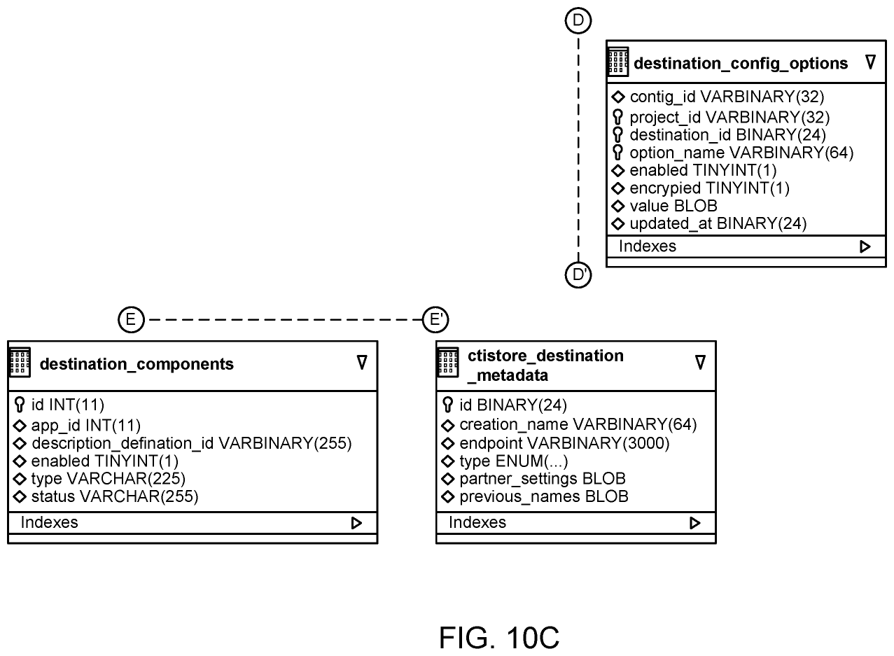

FIG. 10 is a block diagram depicting an example database configuration. Destination action definitions may be configured to get as close as possible to storing the entire destination as configuration in a database. That means several new constructs to may be introduced into the schema, including, for example:
authentication: scheme, and/or fields;
default actions; and/or
actions: display data, fields, default subscription, default field mappings, and/or foreign keys

New Definition Tables: Actions may have their own metadata for display and execution. 2 new definition tables may be introduced—1 for the action itself, and 1 for the action's fields (or settings). A new table for the fields may be introduced because the classic destination_definition_options table contains many irrelevant columns and is designed for different validation and data type requirements. It also would require modification to differentiate action-specific fields from global destination settings. Introducing a new table avoids this nuance by having a dedicated schema to represent action-specific things.

```
  CREATE TABLE IF NOT EXISTS
′ctlplane′.′destination_definition_actions′ (
    ′id′ INT NOT NULL COMMENT ′The primary key of the action′,
    ′destination_id′ BINARY(24) NOT NULL COMMENT ′The
associated destination definition id of the action.′,
    ′slug′ VARBINARY(64) NOT NULL COMMENT ′A machine
readable key unique to the action definition.′,
    ′title′ VARBINARY(64) NOT NULL COMMENT ′A human
readable title for the action.′,
    ′description′ BLOB NOT NULL COMMENT ′A human readable
description of the action. You can use Markdown.′,
    ′created at DATETIME NOT NULL,
    ′updated at′ DATETIME NULL,
    ′PRIMARY KEY ( id )
  )
```

```
  CREATE TABLE IF NOT EXISTS
′ctlplane′.′destination_action_fields′ (
    ′id′ INT NOT NULL COMMENT ′The primary key of the field.′,
    ′destination definition action id′ INT NOT NULL COMMENT
′The id of the action this field belongs to.′,
    ′key′ VARBINARY(45) NOT NULL COMMENT ′A unique
machine readable key for the field. Should ideally match the expected key in the
action\′s API request.′,
    ′label′ VARBINARY(64) NOT NULL COMMENT ′A human
readable label for this value.′,
    ′type′ ENUM(′string′, ′text′, ′number′, ′integer′, ′datetime′, ′boolean′,
′password′) NOT NULL COMMENT ′The data type of this value. String values
from the browser will be coerced accordingly.′,
    ′description′ BLOB NOT NULL COMMENT ′A human readable
description of this value. You can use Markdown.′,
    ′placeholder′ BLOB NULL COMMENT ′An example value
displayed but not saved.′,
    ′default_value′ BLOB NULL COMMENT ′A default value that is
saved the first time an action is created.′,
    ′required′ TINYINT NOT NULL COMMENT ′Whether or not this
field is required′,
    ′multiple′ TINYINT NOT NULL COMMENT ′Whether or not a
user can provide multiples of this field.′,
    ′choices′ JSON NULL COMMENT ′A list of machine readable
value/label pairs to populate a static dropdown.′,
    ′dynamic′ TINYINT NOT NULL COMMENT ′Whether or not this
field should execute a dynamic request to fetch choices to populate a dropdown.
When true, ′choices′ is ignored.′,
    ′pattern′ VARBINARY(64) NULL COMMENT ′An optional
pattern for validation. Can be a regex pattern or known format (e.g. ′date′, ′time′,
′email′, ′hostname′, ′uri′, ′ipv4′)′,
    ′created_at′ DATETIME NOT NULL,
    ′updated_at′ DATETIME NULL,
    PRIMARY KEY (′id′)
  )
```

New Config Tables:

Similar to definitions, destination config (or instances) may include introducing 2 new tables—1 table to hold each action that a customer has configured, and another for the action's customer settings (the raw values containing literal values and mapping directives).

```
  CREATE TABLE IF NOT EXISTS
′ctlplane′.′destination_config_actions′ (
    ′id′ INT NOT NULL,
    ′destination_id′ BINARY(24) NOT NULL COMMENT ′The
associated destination definition id.′,
    ′destination_config_id′ BINARY(24) NOT NULL COMMENT
′The associated destination config.′,
    ′name′ VARCHAR(45) NOT NULL COMMENT ′A human
readable name for the subscription/action.′,
    ′subscription′ BLOB NOT NULL COMMENT ′An FQL query
describing which events to subscribe to.′,
    ′action′ INT NOT NULL COMMENT ′A reference to an action
associated with a given destination config.′,
    ′created_at′ TIMESTAMP NOT NULL,
    ′updated_at′ TIMESTAMP NULL,
    ′enabled′ TINYINT NOT NULL COMMENT ′Whether or not the
subscribed action is enabled.′,
    PRIMARY KEY (′id′),
    INDEX ′destination_config_id_idx′ ( destination_config_id′ ASC)
VISIBLE,
    CONSTRAINT ′destination_id′
      FOREIGN KEY ( )
      REFERENCES ′ctlplane′. ′destination_definition′ ( )
      ON DELETE NO ACTION
      ON UPDATE NO ACTION,
    CONSTRAINT ′destination_config_id′
      FOREIGN KEY (′destination_config_id′)
      REFERENCES ′ctlplane′.′destination_config′ (′destination_id′)
      ON DELETE CASCADE
      ON UPDATE NO ACTION
  )
```

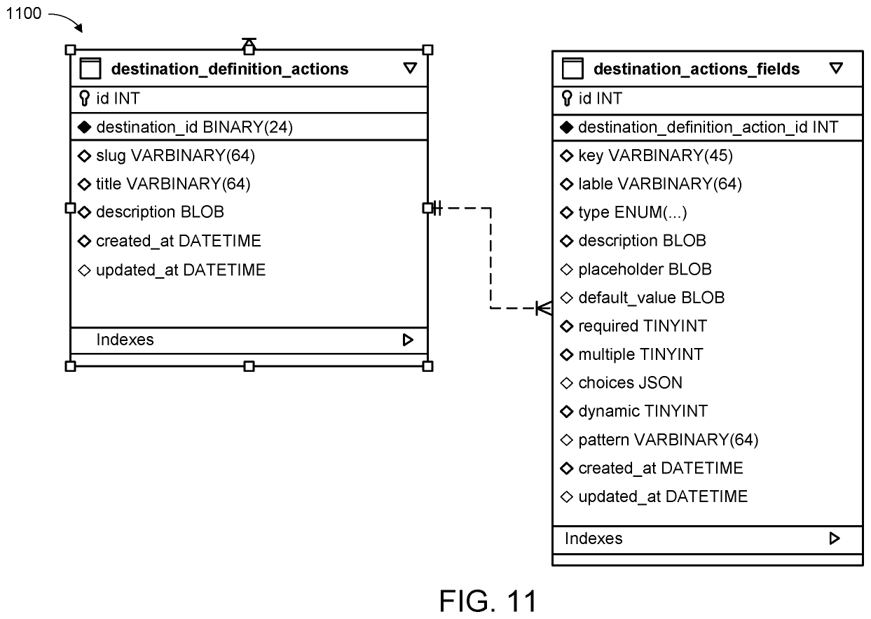

FIG. 11 depicts an example of a database table 1100 that may be created.

```
  CREATE TABLE IF NOT EXISTS
′ctlplane′.′destination_config_action_settings′ (
    ′id′ INT NOT NULL,
    ′destination_config_action_id′ INT NOT NULL COMMENT ′The
associated action id.′,
    ′destination_config_id′ VARBINARY(32) NOT NULL
COMMENT ′The associated config id.′,
    ′field′ VARCHAR(64) NOT NULL COMMENT ′The key of the
field this value belongs to.′,
    ′value′ BLOB NOT NULL COMMENT ′A string representation of
the field′s value.′,
    ′updated_at′ DATETIME NOT NULL COMMENT ′When the
value was last set (created or updated).′,
    PRIMARY KEY (′id′),
    INDEX ′destination_config_action_id_idx′
(′destination_config_ action_id′ ASC) VISIBLE,
    INDEX ′destination_config_id_idx′ (′destination_config_id′ ASC)
VISIBLE,
    CONSTRAINT ′destination_config_id′
      FOREIGN KEY (′destination_config_id′)
      REFERENCES ′ctlplane′.′destination_config′ (′id′)
      ON DELETE CASCADE
      ON UPDATE NO ACTION,
    CONSTRAINT ′destination_config_action_id′
      FOREIGN KEY (′destination_config_action_id′)
      REFERENCES ′ctlplane′.′destination_config_actions′ (id′)
      ON DELETE CASCADE
      ON UPDATE NO ACTION
  )
```

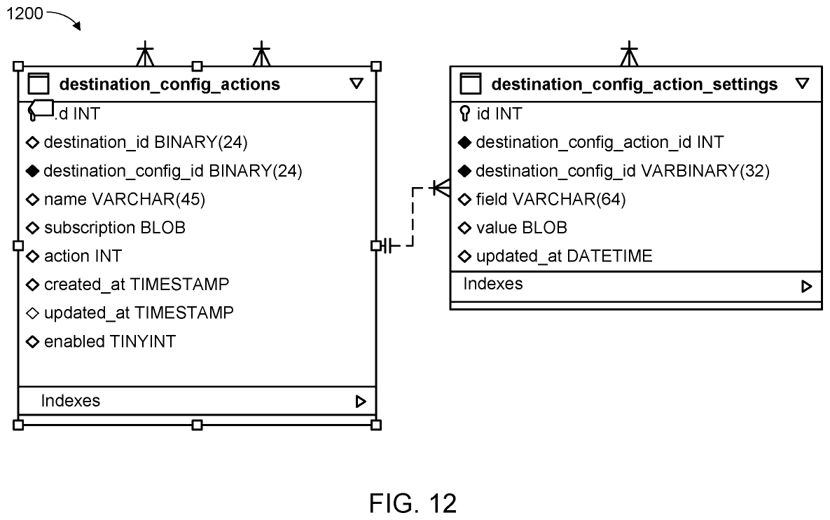

FIG. 12 depicts an example of a database table 1200 that may be created.

Dynamic Input Fields

Some input fields require data from the partner API so users can select from more human-friendly options, or to curate the list of available options to ones that customer can access.

The way these fields work is that the system may make alive request when a user focuses a field in the Action Editor that requires dynamic data. This request may hit a control-plane instance of the destination actions service which knows how to perform the request to the partner API for a given field.

In example embodiments, the system may deploy a service that has restricted routing that matches the security groups used for the integrations cluster. This may prevent loopback requests and block requests to other restricted CIDR subnets. The system needs to protect the service because some destinations may accept arbitrary input and use it as the external URL for the request (e.g., Slack accepts a webhook URL as a customer-provided field).

Testing Support

Customers can test their action configuration with sample events. The way this works is that the UI sends a live request through gateway-api and a control-plane instance of the destination action service with the sample event and the customer's action configuration. The destination action service may run the request input through all the same steps as it does for a request from Centrifuge. The results provide helpful detail for users to tweak their configuration and see how it works.

Note: this may make a live request to the partner API. It behaves similarly to an Event Tester except is scoped to a particular action and uses unsaved configuration changes in the request.

Developer Tooling (DX)

A simple command line interface (CLI) is provided for scaffolding new destinations and actions, publishing changes to staging or production, and other helpful utilities (like auto-generating types).

Action Destination

A destination that is built using the ‘actions’ framework. Destinations built using a monoservice are commonly referred to as ‘classic’ destinations.

Action

A set of input fields plus a perform method implementation that sends some piece of data to the partner's api. Typically actions will match up one to one with the various partner APIs that exist (e.g., logEvent) and not necessarily the system event types (e.g., track)

Subscription

An instance of an ‘action’ in the user's destination. Subscriptions consist of a set of mappings, the ‘trigger’ string in a query language used to determine when the action should be run based on keys present on the incoming event. It is possible to have multiple subscriptions, as well as duplicate subscriptions for a given destination instance.

Preset

One or more builder defined subscription(s) that are automatically created when a user creates a new action destination instance in their workspace. These can be thought of as ‘default subscriptions’. A preset may include one or more of: the action to invoke, a default subscription string in query language, or a set of mappings to use on the action.

Mapping

A data structure (e.g., an object) defined using a combination of literals and mapping-kit directives which ‘maps’ fields from the system Event Spec into the format that the builder's API expects. Mappings are also user configurable so that customizations may be done per subscription by the user if the defaults provided by the builder don't match their implementation or custom needs.

Cloud Destination

A destination that uses the system event pipeline completely to send its data to the partner APIs.

Web Destination

A destination that uses a ‘wrapper’ (e.g., using AJS2.0) to execute the actions framework in browser. This runs directly on the client side and does NOT go through the system event pipeline.

Hybrid Destination

An actions destination that has individual actions that run in browser and in cloud mode. (This is specified at the action level) Currently Amplitude is a good example of this as it uses AJS2.0 to invoke a session plugin which enhances the system event with local cookie data from the customer's site, while the actual data processing is done in ‘cloud’ mode.

How to create and deploy a new web action destination (Example)

Creation—Step #1—Create the Destination
aws-okta exec plat-write -- ssh workbench-prod
goto action destinations
unset NPM_CONFIG_PREFIX
nvm use
git checkout main && git pull
yarn install
bin/run register
Creation—Step #2—Sync the Production db to Staging (Take a while, and Sometimes Fails)
goto sprout
make build-and-import fixture=destinations

Creation—Step #3—Login to Partner Portal and Change its Visibility

Login into partner portal, look for the newly created destination and change its visibility to “Private Beta”.

Now, for deploying code after it has been merged.
aws-okta exec plat-write -- ssh workbench-prod
goto action destinationS
unset NPM_CONFIG_PREFIX
nvm use
git checkout main && git pull
yarn install
bin/run push
bin/run push-browser-destinations -e production

To start using a new destination go to a workspace (e.g., https://app.segment.com/YOURWORKSPACE/destinations/catalog/NEW_DESTINATION_SLUG)

Checklist
Create the new destination
Sync the new destination from prod to staging
Merge your PR
bin/run push
bin/run push-browser-destinations -e production

How to Deploy Updates to an Existing Cloud Action Destination (Example)

Update—Step 1:

Merge your pull request into the main branch of action-destinations repo

Update—Step 2:

First time Setup:
npm login
yarn login
brew install gitleaks/version 8.2.5 at the time of writing

On your local computer run the following:
goto action-destinations
nvm use
yarn
yarn build
//if the build is successful
yarn lerna publish <major|minor|patch>

Copy the new package version(s) that lerna outputs as you will need them in later steps.

Update—Step 3:

Updating library versions in our testing service
in the actions module and/or integrations service
yarn add @segment/action-destinations@<version from above>

Commit and open a PR with the resulting lockfile/package.json changes. Upon merging changes will be autodeployed via treb. Currently (Mar. 25, 2022) this service only runs in the US, and EU traffic is pointed cross datacenter so no EU deployment is necessary.

Update—Step 4:

Update—Step 5:

Push our updated definitions to the control plane

Checklist

Merge your actions PR

Publish

Open a PR to update integrations actions library version

Run Quasar

Open a PR to update the actions module and/or integrations service actions library version

Open PR(s) to update integrations terracode (stage, then canary, then prod)

Open a PR to update integrations EU (eks): +Deploying integrations in the EU

Push Definitions (if Applicable)

How to deploy updates to an existing web action destination
aws-okta exec plat-write -- ssh workbench-prod
goto action destinations
unset NPM_CONFIG_PREFIX
nvm use
git checkout main && git pull
yarn install
bin/run push
bin/run push-browser-destinations -e production

Checklist

Merge your PR
bin/run push
bin/run push-browser-destinations -e production

Overview

The following paragraphs describe an example JavaScript DSL that defines an action-based destination to help destination builders create and update destinations in code.

What's the Destination Action Interface?

A destination actions interface is a single exported object (e.g., a *JSON object) that defines a destination and its actions that gets uploaded to the system's database of destination definitions. From this interface the system understands what the destination can do and what options customers are presented in the Action Editor. The interface is designed to work with a new integrations “engine” that knows how to handle action-based destinations, granular field transformations, and more.

The interface is composed of a couple key components:

Authentication, which lets the system know what credentials the destination needs from customers. This is used during the “Connect Destination” step in the creation flow.

Actions, which send data to the partner API. These are used in the Action Editor where customers configure how a system event gets delivered to the partner API.

*This example implementation is mostly JSON plus a some non-serializable JavaScript code (e.g., that doesn't get uploaded to the system destination database). Other implementations are contemplated. For example, the system could upload the code to Lambda, swapping out function ref ids to store in the database.

How does the Actions CLI Work?

The CLI tool used with Destination Actions introspects the destination interface defined in the action-destinations repository to upload it to the system's destination definition tables (control plane database).

You can see what's supported by running the CLI with the --help flag:
./bin/run --help

Note: the CLI (./bin/run) may only be available when the current working directory is the root of the action-destinations repo.

Developers building destinations in action-destinations can update definitions from the codebase:
#access staging workbench
robo stage.ssh
#open up the repository and install dependencies yarn
goto action-destinations && yarn install
#sync local definitions with the remote database (staging in this case)
./bin/run push

These destinations can be viewed in a Partner Portal, as with any destination:

Authentication-specific fields are not displayed in Partner Portal

Actions are not displayed in Partner Portal

Quick Start Guide

First, scaffold the new destination using the command line scripts. This will create the initial directory structure, and allow the building of the destination interface to start.
#check out the repository+install dependencies
goto action-destinations
yarn install
yarn build
#scaffold a new destination
./bin/run init

The CLI may prompt for a couple details that are used to scaffold the new destination. Now the interface can be defined!
#navigate to the destinations directory. The new destination has its own directory there.
code./packages/destination-actions/src/destinations

After filling out a couple details (intellisense will help) in the destination interface a first action can be scaffolded.
#scaffold a new action within a destination
./bin/run generate.action ACTION_NAME <browser|server>

The CLI may prompt for a couple more details like it did for destination creation.

Example Destination

Local File Structure

In the destination's folder, this general structure may be seen. This index.ts is the entry point to a destination—the CLI expects a destination definition to be exported from there.

$ tree packages/destination-actions/src/destinations/slack
packages/destination-actions/src/destinations/slack

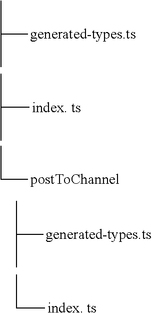

Local Destination Definition

The main definition of a Destination may look something like this, and is what the index.ts should export as the default export:

```
  const destination = {
    name: ′Example Destination′,
    // a human-friendly description that
    gets displayed to users. supports
markdown
    description: ″,
    // see ″Authentication″ section below
    authentication: { },
    // see ″HTTP Requests″ section below
    extendRequest: () => {
    // see ″Actions″ section below
    actions:
  }
  export default destination
```

Authentication

Nearly all destinations require some sort of authentication—and the system's Destination interface provides details about how customers need to authenticate with a destination to send data or retrieve data for dynamic input fields.

Basic Authentication

Basic authentication is useful if a destination requires username and password to authenticate. These are values that only the customer and the destination know.

Tip

When scaffolding an integration a Basic Auth template may be used; e.g., by passing --template basic-auth (or selecting it from the auto-prompt)

```
  const authentication = {
    // the ′basic′ authentication scheme tells the system to automatically
    // include the ′username′ and ′password′ fields.
    // The system will automatically do base64 header encoding of the
username:password
    scheme: ″basic′,
    fields: {
      username: {
        label: ′Username′,
        description: ′Your username′,
        type: ′string′,
        required: true
      },
      password: {
        label: ′password′,
        description: ′Your password.′,
        type: ′string′,
        required: true
      }
    },
    // a function that can test the user′s credentials
    testRequest: (request) => {
      return request(′https://example.com/api/accounts/me.json′)
    }
  }
  const destination = {
    // ...other properties
    authentication,
    extendRequest( { settings }) {
      return {
        username: settings.username,
        password: settings.password
      }
    }
  }
```

Tasks remaining to fully support the “basic” authentication scheme:
use base64 header encoding automatically (got does this for free when passing username, password)
automatically infer username/password fields when uploading the schema to db

Custom Authentication

Custom authentication is perhaps the most common type of authentication seen—it's what most “API Key” based authentication should use. Developers may need to define an extendRequest function to complete the authentication by modifying request headers with some authentication input fields.

```
  const authentication = {
    // the ′custom′ scheme doesn′t do anything automagically, but allows
    // defining of the behavior through input fields and ′extendRequest″.
    // this is what most API key-based destinations should use
    scheme: ′custom′,
    // a function that can test the user′s credentials
    testRequest: (request) => {
      return request( /accounts/me.json′)
    },
    // fields that are specific to authentication
    fields: {
      subdomain:
        type: ′string′,
        label: ′Subdomain′,
        description: ′The subdomain for your account, found in your user
settings.′,
      required: true
      },
      apiKey: {
        type: ′string′,
        label: ′API Key′,
        description: ′Found on your settings page.′,
        required: true
      }
    }
  }
  const destination = {
    // ...other properties
    authentication,
    // we may explore a simple JSON representation that supports
template strings
    extendRequest: ({ settings }) => {
      return {
        prefixUrl: ′https://${settings.subdomain}.example.com/api′,
        headers: { Authorization: ′Bearer ${settings.apiKey}′ },
        responseType: ′json′
      }
    }
  }
```

Note: in the example above input fields are defined that are specific to authentication. Refer to the “Input Fields” section below for more details on how those fields can be defined.

OAuth2 Authentication Scheme

OAuth2 Authentication scheme is the model to be used for those destination APIs which support OAuth 2.0. Developers may be able to define a refreshAccessToken function if developers want the framework to refresh expired tokens.

Developers may have a new auth object available in extendRequest and refreshAccessToken which may surface a destination's accessToken, refreshToken, clientId and clientSecret (these last two only available in refreshAccessToken).

Most destination APIs expect the access token to be used as part of the authorization header in every request. Developers can use extendRequest to define that header.

```
  authentication: {
    scheme: ′oauth2′,
    fields: {
      subdomain: {
        type: ′string′,
        label: ′Subdomain′,
        description: ′The subdomain for your account, found in your
user settings.′,
        required: true
      }
    },
    testAuthentication: async (request) => {
      const res = await
request<UserInfoResponse>(′https://www.example.com/oauth2/v3/userinfo′, {
        method: ′GET′
      })
      return { name: res.data.name}
    },
    refreshAccessToken: async (request, { settings, auth }) => {
      const res = await
request<RefreshTokenResponse>( https://${settings.subdomain}.example.com/api/
oauth2/token′, {
        method: ′POST′,
        body: new URLSearchParams({
          refresh_token: auth.refreshToken,
          client_id: auth.clientId,
          client_secret: auth.clientSecret,
          grant_type: ′refresh_token′
        })
      })
      return { accessToken: res.data.access_token }
    }
    },
    extendRequest({ auth }) {
    return {
      headers: {
        authorization: ′Bearer ${auth?.accessToken}′
      }
    }
  }
```

Note: OAuth directly depends on the oauth providers available in oauth-service. Developers can follow the process of Adding a new OAuth provider before using the oauth2 scheme in an action.

Note 2: As of November 2021, the OAuth tokens used in the integrations mono-service part need to be added to integration-actions chamber instead of the traditional one. For more clarification, oauth integrations require secrets (client id/secret) that are stored in chamber. Previously, they were in chamber's integrations service name, but now they are stored under the integrations-actions service name in chamber.

Unsupported Authentication Schemes

The system may provide built-in support for more authentication schemes. These might include:

Session Authentication

Digest Authentication

OAuth1

Actions

Actions are the way developers define what a destination is able to do. They tell the system how to send data to a destination API. Here's a simple example of a Slack “Post to Channel” action:

```
  const destination = {
    // ...other properties
    actions: {
      postToChannel: {
        // the human-friendly display name of the action
        title: ′Post to Channel′,
        // the human-friendly description of the action. supports
markdown
        description: ″,
        // whether or not this should appear in the Quick Setup
        recommended: true,
        // fql query to use for the subscription initially
        // required if using ′recommended: true′
        defaultSubscription: ′type = ″track″′
        // the set of fields that are specific to this action
        fields: {
          webhookUrl: {
            label: ′Webhook URL′,
            description: ′Slack webhook URL.″,
            type: ′string′,
            format: ′uri′,
            required: true
          },
          text: {
            label: ′Message′,
            description: ″The text message to post to Slack. You can use
[Slack′s formatting syntax.](https://api.slack.com/reference/surfaces/formatting)″,
            type: ′string′,
            required: true
          }
        },
        // the final logic and request to send data to the destination′s API
        perform: (request, { settings, payload }) => {
          return request.post(payload.webhookUrl, {
            responseType: ′text′,
            json: {
              text: payload.text
            }
          })
        }
      }
    }
  }
```

Input Fields

For each action or authentication scheme developers can define a collection of inputs as fields. Input fields are what users see in the Action Editor to configure how data gets sent to the destination or what data is needed for authentication. These fields (for the action only) are able to accept input from the system event.

Input fields have various properties that help define how they are rendered, how their values are parsed and more. Here's an example:

```
const destination = {
  // ...other properties
  actions: {
    postToChannel:
      // ...
      fields: {
        webhookUrl: {
          label: ′Webhook URL′,
          description: ′Slack webhook URL.′,
          type: ′string′,
          required: true
        },
        text:
          label: ′Message′,
          description: ′The text message to
          post to Slack′,
          type: ′string′,
          required: true
        }
      }
    }
  }
}
```

Dynamic Dropdowns

Some APIs require users to specify a related object or resource by id. Unfortunately, this is rather unintuitive for people who don't speak or memorize ids. Dynamic dropdowns offer users a way to select those ids with human-readable labels.

The system may present users with a dropdown that makes a live request to the destination API to fetch those options.

To define a dynamic dropdown, add a dynamic boolean to the field. The system will know to use the same field key in dynamicFields to dynamically resolve the options for the field:

```
const destination = {
  // ...other properties
  actions: {
    postToChannel: {
      // ...
      fields: {
        // ...
        channel: {
          label: ′Channel′,
          description: ′The Slack channel to post to.′,
          type: ′string′,
          // this tells the system to use the matching
          key (′channel′) in
          //`dynamicFields′ to dynamically resolve
          the options for the
          field
          dynamic: true
        }
      },
      dynamicFields: {
        // channel can be async or return a Promise
        channel: (request, { settings, payload }) => {
          return {
            data: [
              { label: ′#foo′, value: ′123456′ },
              { label: ′#bar′, value: ′987654′ }
            ],
            pagination: {
              nextPage: ′2′
            }
          }
        }
      }
    }
```

When a user focuses this field, the UI may make a request to the backend which may execute the dynamicFields.channel function. This function can make a request to a partner API or do execute some additional logic before returning an array of data (human-readable labels and machine-readable values) and any pagination metadata (optionally).

A dynamic dropdown can depend on settings and from other input fields via payload (note, there may not be a value yet).

Default Values

Developers can set default values for fields. These defaults are not used at run-time, however. These defaults pre-populate the initial value of the field when users first set up an action.

Default values can be literal values that match the type of the field (e.g., a literal string: “hello”) or they can be mapping-kit directives just like the values from the system's rich input in the user interface. It's likely that developers will want to use directives to the default value. Here are some examples:

```
const destination = {
  // ...other properties
  actions: {
    doSomething: {
      // ...
      fields: {
        name: {
          label: ′Name′,
          description: ′The person\′s name′,
          type: ′string′,
          default: { ′@path′: ′$.traits.name′ },
          required: true
        },
        email: {
          label: ′Email′,
          description: ′The person\′s email address′,
          type: ′string′,
          default: { ′@path′: ′$.properties.email_address′ }
        }
      }
    }
  }
}
```

In addition to default values for input fields, developers can also specify the defaultSubscription for a given action—this is the query (e.g., FQL query) that may be automatically populated when a customer configures a new subscription triggering a given action.

```
  Input Field interface
  Here′s the full interface that input fields allow:
  interface InputField {
    /** A short, human-friendly label for the field */
    label: string
    /** A human-friendly description of the field */
    description: string
    /** The data type for the field */
    type: ′string′ | ′text′ | ′number′ | ′integer′ | ′datetime′ | ′boolean′
′password′ | ′object′
    /** Whether null is allowed or not */
    allowNull?: boolean
    /** Whether or not the field accepts multiple values (an array of
′type′) */
    multiple?: boolean
    /** An optional default value for the field */
    default?: string | number | boolean | object | Directive
    /** A placeholder display value that suggests what to input */
    placeholder?: string
    /** Whether or not the field supports dynamically fetching options
*/
    dynamic?: boolean
    /* Whether or not the field is required */
    required?: boolean
    /**
      * Optional definition for the properties of type: ′object′′ fields
      * (also arrays of objects when using multiple: true′)
      * Note: this part of the schema is not persisted outside the code
      but is used for validation and typedefs
      */
    properties?: Record<string, InputField>
    /**
      * Format option to specify more nuanced ′string′ types
      * @see {@link https://github.com/ajv-
validator/ajv/tree/v6#/formats}
      */
    format?:
        | ′date′ // full-date according to RFC3339.
        | ′time′ // time with optional time-zone.
        | ′date-time′ // date-time from the same source (time-zone is
mandatory). date, time and date-time validate ranges in full mode and only regexp
in fast mode (see options).
        | ′uri′ // full URI.
        | ′uri-reference′ // URI reference, including full and relative URIs.
        | ′uri-template′ // URI template according to RFC6570
        | ′email′ // email address.
        | ′hostname′ // host name according to RFC1034.
        | ′ipv4′ // IP address v4.
        | ′ipv6′ // IP address v6
        | ′regex′ // tests whether a string is a valid regular expression by
passing it to RegExp constructor.
        | ′uuid′ // Universally Unique IDentifier according to RFC4122.
        | ′password′ // hint to the UI to hide/obfuscate input strings (applied
automatically when using type: ′password″
        | ′text′ // longer strings (applied automatically when using type:
′text′′
  }
  The perform function
```

The perform function defines what the action actually does. All logic and request handling happens here. In example embodiments, every action MUST have a perform function defined.

By the time the actions runtime invokes an action's perform, payloads have already been resolved based on the customer's configuration, validated against the schema, and can be expected to match the types provided in the perform function. Developers may get compile-time type-safety for how developers access anything in the data.payload (the 2nd argument of the perform).

A basic example:

```
  const destination = {
    actions: {
      someAction: {
        // ...
        fields: {
          greeting: {
            label: ′Greeting′,
            description: ′The text message to send′,
            type: ′string′,
            required: true
          }
        },
        // ′perform′ takes two arguments:
        // 1. the request client instance (extended with a destination′s
′extendRequest′
        // 2. the data bundle which includes ′settings′ for top-level
authentication fields and the payload′ which contains all the validated, resolved
fields expected by the action
        perform: (request, data) => {
          return request(′https://example.com′, {
            headers: { Authorization: ′Bearer ${data.settings.api_key}′ },
            json: data.payload
          })
        }
      }
    }
  }
```

The perform method may be invoked once for every event subscription that triggers the action. If developers need to support batching, the system defines a performBatch function.

Batching Requests

If a developer's API supports batching-receiving many objects at once in a single request-developers should consider adding batch support to their destination.

To add support for batching, add a performBatch handler alongside the single-request perform method in the action definition. The method signature is identical except that payload is an array of data, where each object matches the action's field schema.

```
  performBatch: (request, { payload }) => {
    // You can expect these to be the same
    across all payloads as they
are used to
    // group events into batches.
    const { url, method } = payload[0]
    return request(url, {
      method: method as RequestMethod,
      json: payload. map(({ data }) => data)
    })
  }
```

By adding a performBatch method, the action may automatically get an “Enable Batching” setting that allows customers to choose if they want batching disabled (lower latency, more requests) or enabled (higher latency, fewer requests).

Keep in mind a few important things about how batching works:

Batching can add latency while the system accumulates events in batches internally. This can be up to 30 seconds, currently, but this is subject to change at any time.

Batches may have to up 1,000 events, currently. This, too, is subject to change.

Batch sizes are not guaranteed. Due to the way that batches are accumulated internally, developers may see smaller batch sizes than they expect when sending low rates of events.

Quick Setup” Actions

Developers may want to provide a smooth and complete out of the box experience when a customer connects to a destination. The system may consider this the “Quick Setup.” In order to tell the system which subscriptions, actions, and defaults to automatically include when a customer connects a new instance of a destination, developers can use the presets array.

This array lets developers define preset subscriptions that may automatically be included via the Quick Setup, allowing the developer (e.g., the builder), to define the subscription that should trigger a given action, the default “mappings”, the display name for the subscription. Developers can define the display order of presets in the Quick Setup by changing the order in this presets array—the system may respect that order in most views (some places may alphabetize this list by name, however).

Note: presets are expected to have values for all of the corresponding action's required fields, otherwise the action may be excluded from the Quick Setup. This is because without those defaults, the action needs additional configuration to get set up and may not work out of the box.

```
const destination = {
  // ...other properties
  presets: [
    {
      name: ′Order Completed Events′,
      subscribe: ′type = ″track″ and event = ″Order Completed″′,
      partner Action: ′logEvent′,
      mapping: { ... } // must include values for all required fields
    }
  ]
}
```

HTTP Requests

Today, there is only one way to make HTTP requests in a destination: Manual HTTP Requests.

Developers can use the request object to make requests and curate responses. This request is injected as the first argument in all operation functions in the definition (for example, in an action's perform function).

In addition to making manual HTTP requests, developers can use the extendRequest helper to reduce boilerplate across actions and authentication operations in the definition:

```
const destination = {
  // ...other properties
  extendRequest: (request, { settings }) => {
    return
      headers: { Authorization: ′Bearer ${settings.apiKey}′ }
    }
  },
  actions: {
    doA Thing: {
      // ...other properties
      perform: (request, data) => {
        // this request will have the Authorization header
        return request(′https://example.com/api/me.json′, {
          method: ′post′,
          json: data
        })
      }
    }
  }
}
```

HTTP Request Options

The request client is a thin wrapper around a Fetch API, made available both in Node (via node-fetch) and in the browser (with the whatwg-fetch ponyfill as needed).

Both the request(url, options) function and the extendRequest return value also support all of the Fetch API and some additional options:
method: HTTP method, default is GET.
headers: HTTP request headers object as a plain object {foo: 1, bar: true}.
json: shortcut to automatically JSON.stringify into the request body and set the content-type header to application/json.
password: Basic authentication password field. Will automatically get base64 encoded with the username and added to the request headers: Authorization: Basic <username:password>
searchParams: URLSearchParams or a plain object that developers want included in request url's query string.
throwHttpErrors: whether or not the request should throw an HTTPError for non-2xx responses. Default is true.
timeout: Time in milliseconds when a request should be aborted. Default is 10000.
username: Basic authentication username field. Will automatically get base64 encoded with the password and added to the request headers: Authorization: Basic <username:password>

```
const response = await request(′https://example.com′, {
  method: ′post′,
  headers: { ′content-type′: ′application/json′ },
  json: { hello: ′world′ },
  searchParams: { foo: 1, bar: true },
  username: ′my′,
  password: ′secret′,
  timeout: 10000,
  throwHttpErrors: true
})
```

Differences from the Fetch API

There are a few subtle differences from the Fetch API which are meant to limit the interface to be a bit more predictable. The system may consider loosening this to match the complete spec.
the url argument can only be a string instead of also accepting a Request object or a URL object.
headers can only be a plain object instead of also accepting a Headers object.
some options and behaviors are not applicable to Node.js and will be ignored by node-fetch.
method will automatically get upcased for consistency.

Deploying

Once a destination is defined (and perhaps once one or more tests have been written) developers are probably ready to deploy to staging or production. Deploying is a two step process that involves pushing definition changes into the system's database and deploying the ECS service(s) that handles requests for these destinations.

Note: If the developer's PR does not include definition changes the developer can skip the “push” steps.

Here is a summary of the prerequisites and deployment steps, followed with more detail for each step:

Prerequisites:

Create the destination in (production) by using the register command

run./bin/run register and select a destination from the menu (developers may need to be on the production workbench). Developers may get the id (and the slug) in the terminal output so they can check it in Partner Portal. (Developers should make sure they have gotten appropriate access to read or write to Partner Portal in order to visit this link).

Verify the destination is in Partner Portal

Sync production destinations to staging with sprout

Requires that developers have prod-write access

Note: this is a step that's required for any kind of destination, and is not specific to action_destinations

Deployment (Cloud Mode only)

Create a Public Repository (e.g., https://github.com/segmentio/action-destinations)

Merge the PR

npm publish using yarn lerna publish <major|minor|patch>

Upgrade @segment/action-destinations in an integrations PR

Merge integrations PR into master (may autodeploy to integration-actions treb service in both production and staging on commit). Developers can manually treb deploy to staging if they want to test the upgrade first.

Upgrade @segment/action-destinations and @segment/actions-core in the actions module and/or integrations service via PR

Merge actions module and/or integration service PR into master (may autodeploy to actions module and/or integration service treb service in production). Developers can manually treb deploy to staging if they want to test the upgrade first.

./bin/run push the definition to staging or production

The code must first be deployed before the system can update the definition. This is because the code is validating payloads based on the schema in code not based on the definition in the db.

Prereq 1. Create the destination with register

To create the destination in production, developers may need to clone the action-destinations repo on the production workbench and use the ./bin/run register command. Select the appropriate destination from the prompt. The command may then prompt the developer to review the definition before continuing.

Note: In order to register browser destinations, the path needs to be passed using -p.

eg: ./bin/run register -p./packages/browser-destinations/src/destinations/friendbuy/index.ts

Once that succeeds, developers should get the destination definition id (and its slug from the review step \hat{ }). Developers can verify it exists by checking Partner Portal.

When developers register a new destination, its id may be printed as a result of the register operation.

If developers are registering a browser destination, they may want to add it to the destinations manifest so the destination is visible in the destination list when running push-browser-destinations. To do so, simply replicate a particular pre-defined pattern using the destination id.

If developers are registering an action destination, they may want to add it to the list of destinations.

Prereq 2. Sync production destinations to staging with sprout

Sprout can take production destination definitions (metadata) and sync them into our staging database. This is important because many parts of the system may rely on a hard-coded destination definition id—so the ids must match across environment. The best way to guarantee this is by building destinations in production and syncing them to staging. Developers can use the build-and-import make command while specifying fixture=metadata.
#go through whatever setup steps ‘sprout’ requires first, then:
$ make build-and-import fixture=metadata

Prereq 3. Set the destination's status to “Private Beta” when ready (Optional)

In example embodiments, in order to connect to the destination in the app, it needs to be in “Private Beta” status or higher. Private Beta destinations won't appear in the catalog without manually including them (like what is done for the Destination Actions category) but developers can connect to them if they link directly to them in the app. When the system registers the destination, it may start as “Private Building”, but when the developer is ready to make it visible/accessible in the app's catalog, the developer can move to a higher status (Private Beta or Public Beta).

1. Merge a PR

Add a label to the PR prior to merging. Valid labels include patch, minor, and major. This label dictates how to increment the version number of the package that the developer will soon be creating. Think of patch as a bug fix, minor as a feature, and major as a breaking change.

Merge the Pull Request to master. The “ops” server (the one that powers the control plane interactions with the destination) may deploy automatically. Developers may need to also git push origin+master:staging to get the ops server in staging in sync with any changes.

Tip: if the developer is testing a destination in staging, the developer can avoid merging their PR into master and test by publishing a “prerelease” package. That way the developer don't disrupt the production/stable package with untested changes. To do this, do not merge the PR and skip step 2. Instead, do the following:

Keep in mind that if the developer wants to test in the app in staging, the developer may also need to push your branch (possibly force push) to the actions module and/or integrations service engine #staging branch (this may autodeploy the Control Plane actions server). Developers can do this with a command like git push origin+yourbranch:staging or git push origin yourbranch:staging --force. Make sure the branch has the latest changes from master before doing this.

2. Publish to NPM

Because these destinations may be currently running in the integrations monoservice, the system may have to publish a version of the package to NPM. There are two ways to publish packages:

Publishing via GitHub Actions (temporarily disabled)

If PR is labeled as directed in step 1, a new package may automatically be published on merge. If developers had forgotten to label the PR before merging, they can manually publish a production package.

Publishing from a machine

In example embodiments, the system may be using lerna, so developers can cut a semver release (major/minor/patch) or a prerelease version that they may install in integrations.

Prior to publishing, make sure to checkout the main branch and pull once the pull request is merged. The publish commands below should be executed on main with the branch merged.

To publish with lerna:

yarn lerna publish <major/minor|patch>

To see what the current version number is, navigate to the action-destinations npm package: (e.g., https://www.npmjs.com/package/@segment/action-destinations)

While the package is being published, developers may be asked to enter an OTP (one-time password). This may be an NPM two-factor authentication code from Okta or Duo.

3. Install the Version in Integrations

To test any changes end to end in any environment, developers may need to deploy the monoservice with them. yarn add @segment/action-destinations@<your-version> will do the trick. The monoservice has special treb servicesfor that only receive actions traffic. This is so the system can deploy more quickly without having to go through the terraform process since these integrations have no impact on any other integrations.

If this is a new Actions Destination and it hasn't yet been registered inside of the integration monoservice, developers may need to do that as well. Add a new entry to the list of Actions Destinations (e.g., https://github.com/segmentio/integrations/blob/master/integrations/index.js #L195)

It should look like:

integration(‘<destination slug>’, ‘<destination id>’, ‘<destination slug without “actions”>’)

Developers can find the destination slug and destination id in partner portal e.g.

While ‘<destination slug without “actions”>’ is usually correct, this value should actually be the exact folder name of the destination in action-destinations/packages/destination-actions/src/destinations

Treb will autodeploy commits (master→production and staging→stage). Developers can also manually deploy builds to staging by using treb deploy:

treb deploy integration-actions -e stage -b<build_sha>

To find the <build_sha>, run the following and look for the branch: treb builds -e stage integration-actions. The build can be tracked in buildkiteand can take a few minutes to run.

4. Install the Version in the Actions Module and/or Integration Service

Developers may also need to deploy the actions module and/or integrations service that is hosted in the actions module and/or integration service-enginerepo. Update action-destinations packages using this command then get the change approved and merged:

yarn add @segment/action-destinations@<your-version>

If updated the actions-core package is updated, don't forget to update that dependency too!

Treb will autodeploy commits (master→production and staging→stage). Developers can also manually deploy builds to staging by using treb deploy:

treb deploy fab-5-ops -e stage -b<build_sha>

To find the <build_sha>, run the following and look for the branch: treb builds -e stage fab-5-ops. The build can be tracked in buildkite and can take a few minutes to run.

5. Push the Destination Definition to Staging

Now the system may need to update the staging database to reflect our local destination definition. Developers can use a CLI script to upload a particular destination's definition to the destination definition database:

```
  # access staging workbench
  robo stage.ssh
  # open up the repository and install dependencies
  goto action-destinations && yarn install
  # sync local definitions with the remote database (staging in this
case)
  ./bin/run push
```

Developers can also sshuttle if they prefer:

```
  # start sshuttling
  robo sshuttle
  # sync local definitions with the remote database (staging in this
case)
  ≈
```

Or, to push a browser action-destination to stage:

# start sshuttling
robo sshuttle
# from your local branch, sync local definitions and push to s3
./bin/run push
./bin/run push-browser-destinations -e stage

Replace with cli push on a destination by destination basis

6. Once Ready, Push to Production

Once developers have tested adequately (which may include manual tests in staging, Event Tester, or Quasar experiments) they can./bin/run push your definition changes to production, and merge their package upgrade PR to integrations #master!

Once developers have merged their PR code into the main branch they can push their updates using the prod workbench. To push a definition to the system's production database, they can use the production workbench:

aws-okta exec prod-write -- ssh workbench-prod

# cd into the action-destinations repo (or ′git clone′ it if necessary)
# Ensure you′re on the latest main branch commit
goto action-destinations
git checkout main && git pull
yarn install
# review your changes and push your definition
./bin/run push

To bring actions changes into another region (e.g., the EU region), developers may need to manually deploy the integrations code in there as well.

To complete a deploy across regions they can go through these steps:

Merge actions PR into integrations (deploys integration-actions service)

Deploy integrations via Terraform

Deploy the actions module and/or integrations service (e.g., fab-5 engine)

Deploy integrations in the EU

To push a browser destination action, use the prod workbench with platform permissions:

#Note, developers may need to first ssh into the prod workbench with prod-write permissions, then exit out and ssh in with plat-write permissions

aws-okta exec plat-write -- ssh workbench-prod

# cd into the action-destinations repo (or ′git clone′ it if necessary)
# Ensure you′re on the latest main branch commit
goto action-destinations
git checkout main && git pull
yarn install
# review your changes and push your definition
./bin/run push
# push the browser destination action to s3
./bin/run push-browser-destinations -e production

Testing

Validating Definitions

In example embodiments, Destination Action definitions are mostly pure JSON, with the exception of a couple of functions. As a result of this structure, it can be incredibly useful to validate or lint the structure itself with static analysis.

Local Actions Server

To test a destination action locally, developers can spin up a local HTTP server through the actions CLI. Once the HTTP server is spun up, developers can send test requests to it and test their changes.

./bin/run serve <DESTINATION>

Notes:
the <DESTINATION> argument in the CLI command is optional. If it's not provided, developers can select the destination through the auto-prompt.
the default port is 3000. To use a different port, developers can change the PORT environment variable (e.g. PORT=3001./bin/run serve)

Once the HTTP server is up and running, developers can make a request using the following URL format: https://localhost:<PORT>/<ACTION>

The request body should look like the following, with key-value pairs corresponding to the chosen destination action. payload, settings, and auth values are all optional but developers must pass in all required fields for the specific destination action under payload.

```
{
  ″payload″: {
    ″client_id″: ″clientid123″,
    ″search_term″: ″Segment″
  },
  ″settings″: {
    ″measurementId″: ″measurement1234″,
    ″apiSecret″: ″secret1234″
  },
  ″auth″: {
    ″accessToken″: ″access1234″,
    ″refreshToken″: ″refresh1234″
  }
}
```

Writing Tests

When developers are building a destination action, they can write unit tests and end-to-end tests that ensure the action is working as intended. Tests are automatically run in Buildkite CI on every pull request commit. Today our unit tests behave a bit more like integration tests in that developers are not only testing the perform operation/unit, but are also testing how events+mappings get transformed and validated.

```
import nock from ′nock′
import { createTestIntegration } from ′@segment/actions-core′
import SendGrid from ′../index′
const testDestination = createTestDestination(SendGrid)
const SENDGRID_API_KEY = ′some random secret′
describe(′SendGrid′, ( ) => {
  describe(′createList′, ( ) => {
    it(′should validate action fields′, async ( ) => {
      try {
        await testDestination testAction(′createList′, {
          settings: { apiKey: SENDGRID_API_KEY },
          skipDefaultMappings: true
        })
      } catch (err) {
        expect(err. message) toContain(″missing the required field
      ′name′.″)
      }
    })
    it(′should work′, async ( ) => {
      nock(′https://api.sendgrid.com/v3′)
        .post(′/marketing/lists′, { name: ′Some Name′ })
        .reply(200)
      await testDestination.testAction(′createList′, {
        mapping: { name: ′Some Name′ },
        settings: { apiKey: SENDGRID_API_KEY }
      })
    })
  })
})
```

Developers can also test their authentication scheme with unit tests

```
  // ...
  describe(‘SendGrid’, ( ) => {
    // ...
    describe(‘authentication’, ( ) => {
      it(‘should validate api keys’, async ( ) => {
        try {
          await testDestination.testAuthentication({ apiKey: ‘secret’ })
        } catch (err) {
          expect(err.message).toContain(‘API Key should be 32
characters’)
        }
      })
      it(‘should test that authentication works’, async ( ) => {
        nock(‘https://api.sendgrid.com/v3’)
          .get(‘/user/profile’)
          matchHeader(‘authorization’, ‘Bearer some valid super secret
api key’)
          .reply(200, { })
        await
expect(testDestination.testAuthentication(settings)).resolves.not.toThrow( )
      })
      it(‘should test that authentication fails’, async ( ) => {
        nock(‘https://api.sendgrid.com/v3’)
          .get(‘/user/profile’)
          .reply(403, {
            errors: [{ field: null, message: ‘access forbidden’ }]
          })
        try {
          await testDestination testAuthentication({ apiKey: ‘nope this is
an invalid key’ })
        } catch (err) {
          expect(err.message) toContain(‘Credentials are invalid’)
        }
      })
    })
  })
```

Mocking HTTP Requests

While testing developers may want to avoid actually hitting external APIs. The system may use nock to intercept requests before they hit the network. For example, the system may use nock to mock different types of requests and responses.

TypeScript

The repository is built with TypeScript and ESLint with a fairly strict configuration. The system may recommend building in VSCode as it has fantastic built-in TypeScript support.

The system may also auto-generate types for destination settings and action fields based on the definition itself. To manually regenerate types as developers make changes to the definition simply run:
#introspect all definitions and re-generate types from them
./bin/run generate:types

Create a New Destination Action

This document describes in detail the steps necessary to create a new Actions-based Destination using the system CLI.

Prerequisites

Before beginning, consider the following prerequisites.

Configure the development environment

Fork the segmentio/action-destinations repository, connect to NPM and Yarn, and ensure a compatible version of Node is installed.

Note: Action-based destinations run several workflows on pull requests, which requires that GitHub actions be enabled in the repository. To prevent workflow failure, GitHub Actions must be enabled on the Actions tab of the forked repository.

Run the test suite to ensure the environment is properly configured.
git clone https://github.com/<your_gh_org>/action-destinations.git
cd action-destinations
npm login
yarn login
#Requires node 14.17, optionally; nvm use 14.17
yarn --ignore-engines --ignore-optional
yarn bootstrap
yarn build
yarn install
yarn test

Create a destination

Once the environment is configured, your first destination may be built. All commands, unless noted otherwise, should run from the root of the project folder. For example, ./action-destinations

Run./bin/run --help at any time or visit the CLI README to see a list of available commands.

Scaffold the new destination

To begin, run./bin/run init to scaffold the project's directory structure, and create a minimal implementation of the new destination. The initialization sets the following information:

Integration name

Integration slug

Authentication template (choose one of Custom Auth, Browser Destination (experimental), Basic Auth, OAuth2 Auth, or Minimal)

After completion, the directory structure of the new destination is created at packages/destination-actions/src/destinations/<slug>. The init command does not register or deploy the integration.

Cloud Mode Destination

The index.ts file in this folder contains the beginnings of an Actions-based Destination. For example, a destination named Test using Basic Auth contains the following:

```
  import type { DestinationDefinition } from ‘@segment/actions-core’
  import type { Settings } from ‘./generated-types’
  const destination: DestinationDefinition<Settings> = {
    name: ‘Test’,
    slug: ‘actions-test’,
    mode: ‘cloud’,
    authentication: {
      scheme: ‘basic’,
      fields: {
        username: {
          label: ‘Username’,
          description: ‘Your Test username’,
          type: ‘string’,
          required: true
        },
        password: {
          label: ‘password’,
          description: ‘Your Test password.’,
          type: ‘string’,
          required: true
        }
      },
      testAuthentication: (request) => {
        // Return a request that tests/validates the user's credentials.
        // If you do not have a way to validate the authentication fields
safely,
        // you can remove the ‘testAuthentication’ function, though
discouraged.
      }
    },
    extendRequest({ settings }) {
      return {
        username: settings.username,
        password: settings.password
      }
    },
    onDelete: async (request, { settings, payload }) => {
      // Return a request that performs a GDPR delete for the provided
userId or anonymousId
      // provided in the payload. If your destination does not support
GDPR deletion you should not
      // implement this function and should remove it completely.
    },
    actions: { }
  }
```

export default destination

Notice the name and slug properties, the authentication object, an extendRequest function that returns the username and password from settings, and an empty actions object.

With this minimal configuration, the destination can connect to the system's user interface, and collect authentication fields. The destination does not do anything at this point, because no Actions are defined.

The testAuthentication function verifies the user's credentials against a service. For testing, enter return true in this function to continue development.

The onDelete function performs a GDPR delete against a service. For testing, enter return true in this function to continue development.

Browser (Device Mode) Destination

```
  import type { Settings } from ‘./generated-types’
  import type { BrowserDestinationDefinition } from ‘../../lib/browser-
destinations’
  import { browserDestination } from ‘../../runtime/shim’
  // Declare global to access your client
  declare global {
    interface Window {
      sdkName: typeof sdkName
    }
  }
  // Switch from unknown to the partner SDK client types
  export const destination: BrowserDestinationDefinition<Settings,
unknown> = {
    name: ‘BrowserExample’,
    slug: ‘actions-browserexample’,
    mode: ‘device’,
    settings: {
      // Add any destination settings required here
    },
    initialize: async ({ settings, analytics }, deps) => {
      await deps.loadScript(‘<path_to_partner_script>’)
      // initialize client code here
      return window.yourSDKName
    },
    actions: { }
  }
```

export default browserDestination(destination)

In Browser Destinations' no authentication is required. Instead, developers must initialize their SDK with the required settings needed.

When importing an SDK, the system may recommend loading from a CDN when possible. This keeps the bundle size lower rather than directly including the SDK in the package.

Developers should make sure to add a global declaration where they specify their SDK as a field of a Window interface so they can reference and return it in their initialize function. E.g., see above.

Actions

Actions define what the destination can do. They instruct the system how to send data to a destination API. For example, consider this “Post to Channel” action from a Slack destination:

```
  const destination = {
    // ...other properties
    actions: {
      postToChannel: {
        // the human-friendly display name of the action
        title: ‘Post to Channel’,
        // the human-friendly description of the action. supports
markdown
        description: ‘Post a message to a Slack channel’,
        // fql query to use for the subscription initially
        defaultSubscription: ‘type = “track”
        // the set of fields that are specific to this action
        fields: {
          webhook Url: {
            label: ‘Webhook URL’,
            description: ‘Slack webhook URL.’,
            type: ‘string’,
            format: ‘uri’,
            required: true
          },
          text: {
            label: ‘Message’,
            description: “The text message to post to Slack. You can use
[Slack's formatting syntax.](https://api.slack.com/reference/surfaces/formatting)”,
            type: ‘string’,
            required: true
          }
        },
        // the final logic and request to send data to the destination's API
        perform: (request, { settings, payload }) => {
          return request.post(payload.webhookUrl, {
            responseType: ‘text’,
            json: {
              text: payload.text
            }
          })
        }
      }
    }
  }
```

Actions best practices

Actions should map to a feature in the developer's platform. Try to keep the action atomic. The action should perform a single operation in the downstream platform.

Define and Scaffold an Action

As mentioned above, actions contain the behavior and logic necessary for sending data to the platform's API.

To create the Post to Channel action above, begin by creating the scaffold on top of which developed may build the action. Run./bin/run generate:action postToChannel server to create the scaffold.

The generate:action command takes two arguments:
The name of the action
The type of action

When creating a scaffold, the CLI also imports the action to the definition of the destination, and generates empty types based on the action's fields.

Add Functionality to the Action

After developers have created the scaffold for the action, they may add logic that defines what the action does. Here, developers define the fields that the action expects to receive, and write the code that performs the action.

Action Fields

For each action or authentication scheme, developers define a collection of inputs and fields. Input fields define what the user sees in the Action Editor within the system's user interface. In an action, these fields accept input from the incoming system event.

The system CLI introspects field definitions when developers run ./bin/run generate:types to generate their TypeScript declarations. This ensures the perform function is strongly-typed.

Define fields following the field schema If the developer's editor or IDE provides good Intellisense and autocompletion, the developer should see the allowed properties.

As mentioned above, the perform function contains the code that defines what the action does.

The system may recommend that developers start with a simple task, and evolve it. Get the basics working first. Add one or two fields to start, then run ./bin/run generate:types when developers change the definition of a field. Run this step manually after changes, or run yarn types --watch to regenerate types when a change is detected.

Write tests

Testing ensures that the destination functions the way the developers expect. For information on testing, see Build and Test Cloud Destinations.

Write documentation

Documentation ensures users of the destination can enable and configure the destination, and understand how it interacts with the developer's platform

Documentation components

Documentation for Destinations consists of one markdown file that explains at a high level:

The purpose of the destination

Benefits of an actions-based destination over a classic destination (if applicable)

Steps to add and configure the destination within the system

Breaking differences with a classic destination (if applicable)

Migration steps (if applicable)

This documentation is stored in the form of a markdown that incorporates information directly from the destination's code (prebuilt mappings, available actions, fields, and settings).

For more information, see the template markdown files:
doc-template-new.md
doc-template-update.md

Submit documentation for review

To add documentation, fork the segmentio/segment-docs repository.

Add the markdown file that was created based on the template above to the following location:

src/connections/destinations/catalog/actions-<destination_name>/index.md

Then submit a pull request.

Actions Tester

In order to see a visual representation of the settings/mappings fields the system provide a tool to preview and execute simulated actions mappings against an in-development destination. For more information on how to use actions tester click here.

Local End-to-End Testing

To test a destination action locally, developers can spin up a local HTTP server through the Actions CLI.

#For more information, add the --help flag

./bin/run serve

The default port is set to 3000. To use a different port, developers can specify the PORT environment variable (e.g. PORT=3001./bin/run serve).

After running the serve command, select the destination to test locally. Once a destination is selected, the server should start up.

To test a specific destination action, developers can send a Postman or cURL request with the following URL format: https://localhost:<PORT>/<ACTION>. A list of eligible URLs may also be provided by the CLI command when the server is spun up.

### Example

The following is an example of a cURL command for google-analytics-4's search action. Note that payload, settings, and auth values are all optional in the request body. However, developers must still pass in all required fields for the specific destination action under payload.

```
curl --location --request POST ‘http://localhost:3000/search’ \
--header ‘Content-Type: application/json’ \
--data ‘{
  “payload”: {
    “client_id”: “<CLIENT_ID>”,
    “search_term”: “<SEARCH_TERM>”
  },
  “settings”: {
    “measurementId”: “<MEASUREMENT_ID>”,
    “apiSecret”: “<API_SECRET>”
  },
  “auth”: {
    “accessToken”: “<ACCESS_TOKEN>”
    “refreshToken”: “<REFRESH_TOKEN>”
  }
}’
```

Testing Batches

Actions destinations that support batching, i.e. that have a performBatch handler implemented, can also be tested locally. Test events should be formatted similarly to the example above, with the exception that payload may be an array. Here is an example of webhook's send action, with a batch payload.

```
curl --location --request POST ‘http://localhost:3000/send’ \
--header ‘Content-Type: application/json’ \
--data ‘{
  “payload”: [{
    “url”: “https://www.example.com”,
    “method”: “PUT”,
    “data”: {
      “cool”: true
    }
  }],
  “settings”: { },
  “auth”: { }
}’
```

Unit Testing

When building a destination action, developers should write unit and end-to-end tests to ensure their action is working as intended. Tests are automatically run on every commit in Github Actions. Pull requests that do not include relevant tests may not be approved.

Today, our unit tests behave more like integration tests in that developers are not only testing the perform operation/unit, but also how events+mappings get transformed and validated.

Run tests for all cloud destinations with yarn cloud test or target a specific destination with the --testPathPattern flag:

yarn cloud test --testPathPattern=src/destinations/sendgrid

Mocking HTTP Requests

While testing, developers want to avoid hitting external APIs. The system may use nock to intercept requests before they hit the network.

### Examples

```
  Testing events + mapping
  import nock from ‘nock’
  import { createTestIntegration } from ‘@segment/actions-core’
  import SendGrid from ‘../index’
  const testDestination = createTestDestination(SendGrid)
  const SENDGRID_API_KEY = ‘some random secret’
  describe(‘SendGrid, ( ) => {
    describe(‘createList’, ( ) => {
      it(‘should validate action fields’, async ( ) => {
        try {
          await testDestination.testAction(‘createList’, {
            settings: { apiKey: SENDGRID_API_KEY },
            skipDefaultMappings: true
          })
        } catch (err) {
          expect(err.message).toContain(“missing the required field
‘name’.”)
        }
      })
      it(‘should work’, async ( ) => {
        nock(‘https://api.sendgrid.com/v3’)
          .post(‘/marketing/lists’, { name: ‘Some Name' })
          .reply(200)
        await testDestination.testAction(‘createList’, {
          mapping: { name: ‘Some Name’ },
          settings: { apiKey: SENDGRID_API_KEY }
        })
      })
    })
  })
  Testing authentication scheme with unit tests
  // ...
  describe(‘SendGrid’, ( ) => {
    // ...
    describe(‘authentication’, ( ) => {
      it(‘should validate api keys’, async ( ) => {
        try {
          await testDestination.testAuthentication({ apiKey: ‘secret’ })
        } catch (err) {
          expect(err.message).toContain(‘API Key should be 32
characters’)
        }
      })
      it(‘should test that authentication works’, async ( ) => {
        nock(‘https://api.sendgrid.com/v3’)
          .get(‘/user/profile’)
          .matchHeader(‘authorization’, ‘Bearer some valid super secret
api key’)
          .reply(200, { })
        await
expect(testDestination.testAuthentication(settings)).resolves.not.toThrow( )
      })
      it(‘should test that authentication fails’, async ( ) => {
        nock(‘https://api.sendgrid.com/v3’)
          .get(‘/user/profile’)
          .reply(403, {
            errors: [{ field: null, message: ‘access forbidden’ }]
          })
        try {
          await testDestination.testAuthentication({ apiKey: ‘nope this is
an invalid key’ })
        } catch (err) {
          expect(err.message).toContain(‘Credentials are invalid’)
        }
      })
    })
  })
```

Snapshot Testing

Snapshot tests help developers understand how their changes affect the request body and the downstream tool. In action-destinations, they are automatically generated with both the init and generate:action CLI commands—the former creating destination-level snapshots and the latter creating action-level snapshots. These tests can be found in the snapshot.test.ts file under the_tests_folder.

The snapshot.test.ts file mocks an HTTP server using nock, and generates random test data (w/Chance) based on the destination action's fields and corresponding data type. For each destination action, it creates two snapshot tests—one for all fields and another for just the required fields. To ensure deterministic tests, the Chance instance is instantiated with a fixed seed corresponding to the destination action name.

Once the actions under a new destination are complete, developers can run the following command to generate a snapshot file (snapshot.test.ts.snap) under/_tests_/snapshots/.

yarn jest --testPathPattern=‘./packages/destination-actions/src/destinations/<DESTINATION SLUG>’--updateSnapshot

Authentication

Nearly all destinations require some sort of authentication—and our Destination interface provides details about how customers need to authenticate with a destination to send data or retrieve data for dynamic input fields.

Basic Authentication

Basic authentication is useful if the destination requires username and password to authenticate. These are values that only the customer and the destination know.

TIP: When scaffolding am integration, developers can use the Basic Auth template by passing --template basic-auth (or selecting it from the auto-prompt)

```
  const authentication = {
    // the ‘basic authentication scheme tells the system to automatically
    // include the ‘username and password’ fields so developers don't
have to.
    // The system may automatically do base64 header encoding of the
username:password
    scheme: ‘basic’,
    fields: {
      username: {
        label: ‘Username’,
        description: ‘Your username’,
        type: ‘string’,
        required: true
      },
      password: {
        label: ‘password’,
        description: ‘Your password.’,
        type: ‘string’,
        required: true
      }
    },
    // a function that can test the user's credentials
    testRequest: (request) => {
      return request(‘https://example.com/api/accounts/me.json’)
    }
  }
  const destination = {
    // ...other properties
    authentication,
    extendRequest({ settings }) {
      return {
        username: settings.username,
        password: settings.password
      }
    }
  }
```

Custom Authentication

Custom authentication is perhaps the most common type of authentication seen—it's what most “APT Key” based authentication should use. Developers may need to define an extendRequest function to complete the authentication by modifying request headers with some authentication input fields.

```
  const authentication = {
    // the ‘custom’ scheme doesn't do anything automagically, but lets
    // the behavior to be defined through input fields and
‘extendRequest’.
    // this is what most API key-based destinations should use
    scheme: ‘custom’,
    // a function that can test the user's credentials
    testRequest: (request) => {
      return request(‘/accounts/me.json’)
    },
    // fields that are specific to authentication
    fields: {
      subdomain: {
        type: ‘string’,
        label: ‘Subdomain’,
        description: ‘The subdomain for your account, found in your user
settings.’,
        required: true
      },
      apiKey: {
        type: ‘string’,
        label: ‘API Key’,
        description: ‘Found on your settings page.’,
        required: true
      }
    }
  }
  const destination = {
    // ...other properties
    authentication,
    // we may explore a simple JSON representation that supports
template strings
    extendRequest: ({ settings }) => {
      return {
        prefixUrl: ‘https://${settings.subdomain}.example.com/api’,
        headers: { Authorization: ‘Bearer ${settings.apiKey}’ },
        responseType: ‘json’
      }
    }
  }
```

OAuth2 Authentication Scheme

OAuth2 Authentication scheme is the model to be used for destination APIs which support OAuth 2.0. Developers may be able to define a refreshAccessToken function if they want the framework to refresh expired tokens.

Developers may have a new auth object available in extendRequest and refreshAccessToken which may surface the destination's accessToken, refreshToken, clientId and clientSecret (these last two only available in refreshAccessToken).

Most destination APIs expect the access token to be used as part of the authorization header in every request. Developers can use extendRequest to define that header.

```
  authentication: {
    scheme: ‘oauth2’,
    fields: {
      subdomain: {
        type: ‘string’,
        label: ‘Subdomain’,
        description: ‘The subdomain for your account, found in your
user settings.’,
        required: true
      }
    },
    testAuthentication: async (request) => {
      const res = await
request<UserInfoResponse>(‘https://www.example.com/oauth2/v3/userinfo’, {
        method: ‘GET’
      })
      return { name: res.data.name}
    },
    refresh Access Token: async (request, { settings, auth }) => {
      const res = await
request<RefreshTokenResponse>(‘https://${settings.subdomain}.example.com/api/
oauth2/token’, {
        method: ‘POST’,
        body: new URLSearchParams({
          refresh_token: auth.refreshToken,
          client_id: auth.clientId,
          client_secret: auth.clientSecret,
          grant_type: ‘refresh_token’
        })
      })
      return { accessToken: res.data.access_token }
    }
  },
  extendRequest({ auth }) {
    return {
      headers: {
        authorization: ‘Bearer ${auth?.accessToken}’
      }
    }
  }
```

Mapping Kit

Mapping Kit is a library for mapping and transforming JSON payloads. It exposes a function that accepts a mapping configuration object and a payload object and outputs a mapped and transformed payload. A mapping configuration is a mixture of raw values (values that appear in the output payload as they appear in the mapping configuration) and directives, which can fetch and transform data from the input payload.

For example:

Mapping:

```
{
  “name”: “Mr. Rogers”,
  “neighborhood”: { “@path”: “$.properties.neighborhood” },
  “greeting”: { “@template”: “Won't you be my
        ?” }
}
Input:
{
  “type”: “track”,
  “event”: “Sweater On”,
  “context”: {
    “library”: {
      “name”: “analytics.js”,
      “version”: “2.11.1”
    }
  },
  “properties”: {
    “neighborhood”: “Latrobe”,
    “noun”: “neighbor”,
    “sweaterColor”: “red”
  }
}
Output:
{
  “name”: “Mr. Rogers”,
  “neighborhood”: “Latrobe”,
  “greeting”: “Won't you be my neighbor?”
}
Usage
import { transform } from ‘../mapping-kit’
const mapping = { ‘@path’: ‘$.foo.bar’ }
const input = { foo: { bar: ‘Hello!’ } }
const output = transform(mapping, input)
// => “Hello!”
```

### Terms

In Mapping Kit, there are only two kinds of values: raw values and directives. Raw values can be any JSON value and Mapping Kit may return them in the output payload untouched:

42
“Hello, world!”
{ “foo”: “bar” }
[“product123”, “product456”]

Directives are objects with a single @-prefixed key that tell Mapping Kit to fetch data from the input payload or transform some data:

{ “@path”: “$.properties.name” }
{ “@template”: “Hello there, ”}

In this document, the act of converting a directive to its final raw value is called “resolving” the directive.

Mixing raw values and directives

Directives and raw values can be mixed to create complex mappings. For example:

Mapping:

```
{
  “action”: “create”,
  “userId”: {
    “@path”: “$.traits.email”
  },
  “userProperties”: {
    “@path”: “$.traits”
  }
}
Input:
{
  “traits”: {
    “name”: “Peter Gibbons”,
    “email”: “peter@example.com”,
    “plan”: “premium”,
    “logins”: 5,
    “address”: {
      “street”: “6th St”,
      “city”: “San Francisco”,
      “state”: “CA”,
      “postalCode”: “94103”,
      “country”: “USA”
    }
  }
}
```

Output:

```
{
  “action”: “create”,
  “userId”: “peter@example.com”,
  “userProperties”: {
    “name”: “Peter Gibbons”,
    “email”: “peter@example.com”,
    “plan”: “premium”,
    “logins”: 5,
    “address”: {
      “street”: “6th St”,
      “city”: “San Francisco”,
      “state”: “CA”,
      “postalCode”: “94103”,
      “country”: “USA”
    }
  }
}
```

A directive may not, however, be mixed in at the same level as a raw value:

Invalid:

```
{
  “foo”: “bar”,
  “@path”: “$.properties.biz”
}
```

Valid:

```
{
  “foo”: “bar”,
  “baz”: { “@path”: “$.properties.biz” }
}
```

And a directive may only have one @-prefixed directive in it:

Invalid:

```
{
  “@path”: “$.foo.bar”,
  “@template”: “{{biz.baz}”
}
```

Valid:

```
{
  “foo”: { “@path”: “$.foo.bar” },
  “baz”: {
    “@template”: “ ”
  }
}
```

Validation

Mapping configurations can be validated using JSON Schema. The test suite is a good source-of-truth for current implementation behavior.

Options

Options can be passed to the transform( ) function as the third parameter:

const output=transform(mapping, input, options)

Available options:

{
merge: true // default false
}
merge

If true, merge may cause the mapped value to be merged onto the input payload. This is useful when developers only want to map/transform a small number of fields:

Input:

```
{
  “a”: {
    “b”: 1
  },
  “c”: 2
}
```

Options:

{
“merge”: true
}

Mappings:

```
{ }
=>
{
  “a”: {
    “b”: 1
  },
  “c”: 2
}
{
  “a”: 3
}
=>
{
  “a”: 3,
  “c”: 2
}
{
  “a”: {
    “c”: 3
  }
}
=>
{
  “a”: {
    “b”: 1,
    “c”: 3
  },
  “c”: 2
}
```

Removing values from object

undefined values in objects are removed from the mapped output while null is not:

Input:

{
“a”: 1
}

Mappings:

```
{
  “foo”: {
    “@path”: “$.a”
},
  “bar”: {
    “@path”: “$.b”
  },
  “baz”: null
}
=>
{
  “foo”: 1,
  “baz”: null
}
```

Directives

@if

The @if directive resolves to different values based on a given conditional. It must have at least one conditional (see below) and one branch (“then” or “else”).

The supported conditional values are:

“exists”: if the given value is not undefined or null, the @if directive resolves to the “then” value. Otherwise, the “else” value is used.

Input:

```
{
  ″a″: ″cool″,
  ″b″: true
}
```

Mappings:

```
{
  ″@if″: {
    ″exists″: { ″@path″: ″$.a″ },
    ″then″: ″yep″,
    ″else″: ″nope″
  }
}
=>
″yep″
{
  ″@if″: {
    ″exists″: { ″@path″: ″$.nope″ },
    ″then″: ″yep″,
    ″else″: ″nope″
  }
}
=>
″nope″
```

if “then” or “else” are not defined and the conditional indicates that their value should be used, the field may not appear in the resolved output. This is useful for including a field only if it (or some other field) exists:

Input:

{
″a″: ″cool″
}

Mappings:

```
{
  ″foo-exists″: {
    ″@if″: {
      ″exists″: { ″@path″: ″$.foo″ },
      ″then″: true
    }
  }
}
=>
{ }
{
  ″a″: {
    ″@if″: {
      ″exists″: { ″@path″: ″$.oops″ },
      ″then″: { ″@path″: ″$.a″ }
    }
  }
}
=>
{ }
@path
```

The @path directive resolves to the value at the given path. @path supports basic dot notation. Like JSONPath, developers can include or omit the leading $.

Input:

```
{
  ″foo″: {
    ″bar″: 42,
    ″baz″: [{ ″num″: 1 }, { ″num″: 2 }]
  },
  ″hello″: ″world″
}
```

Mappings:

{ ″@path″: ″$.hello″ } => ″world″
{ ″@path″: ″$.foo.bar″ } => 42
{ ″@path″: ″$.foo.baz[0].num″ } => 1
@template

The @template directive resolves to a string replacing curly brace placeholders.

Input:

```
{
  ″traits″: {
    ″name″: ″Mr. Rogers″
  },
  ″userId″: ″abc123″
}
```

Mappings:

| | | |
|---|---|---|
| { ″@template″: ″Hello, | | !″ } => ″Hello, Mr. Rogers! |
| { ″@template″: ″Hello, | | !″ }=> ″Hello, !″ |
| { ″@template″: ″ | ( | )″ } => ″Mr. Rogers |
| (abc123)″ | | |
| @literal | | |

The @literal directive resolves to the value with no modification. This is needed primarily to work around literal values being interpreted incorrectly as invalid templates.

Input:
n/a
Mappings:
{ ″@literal″: true } => true
@arrayPath

The @arrayPath directive resolves a value at a given path (much like @path), but allows developers to specify the shape of each item in the resulting array. Developers can use directives for each key in the given shape, relative to the root object.

Typically, the root object is expected to be an array, which may be iterated to produce the resulting array from the specified item shape. It is not required that the root object be an array.

For the item shape to be respected, the root object must be either an array of plain objects OR a singular plain object. If the root object is a singular plain object, it may be arrified into an array of 1.

Input:

```
{
  ″properties″: {
    ″products″: [{ ″productId″: 1 }, { ″productId″: 2 }]
  }
}
```

Mapping:

{
″@arrayPath″: [″$.properties.products″]
}

```
[
  {
    ″productId″: 1
  },
  {
    ″productId″: 2
  }
]
```

Mappings with item shape:

```
{
  ″@arrayPath″: [″$.properties.products″, {
    ″some_other_key″: { ″@path″: ″$.productId″ }
  }]
}
```

Result:

```
[
  {
    ″some_other_key″: 1
  },
  {
    ″some_other_key″: 2
  }
]
```

Destination Kit

Overview

Destination Kit is an interface for building destinations that are composed of discrete actions that users want to perform when using a destination (e.g., “create or update company”, “track user”, “trigger campaign”).

| | |
|---|---|
| | // Create or update a customer record in Customer.io |
| | export default { |
| | fields: { |
| | id: { ... }, |
| | custom_attributes: { ... }, |
| | created_at: { ... }, |
| | // ... more |
| | }, |
| | perform: (request, { payload, settings }) => { |
| | const { id, custom_attributes: customAttrs, created_at, ...body } = |
| payload | |
| | return request(′https://example.com/customers/${id}′, { |
| | method: ′put′, |
| | json: { ...customAttrs, ...body } |
| | }) |
| | } |
| | } |

The goals of Destination Kit are to minimize the amount of work it takes to build a destination (to make them easy to build) and to standardize the most common patterns of destinations (to make them easy to build correctly). Through this standard definition and dependency injection, the system can use the same destination code to generate one or more of multiple things:
JSON Schema validation;
Lambda functions to handle transformation and delivery of events;
Documentation that outlines what a destination can do, what information it needs to perform each action, and how the destination behaves; and/or
Centrifuge GX job configuration to move logic and work out of Lambda piecemeal.

Destination Definition

A Destination definition is the entrypoint for a destination. It holds the configuration for how a destination should be presented to customers, and how it sends incoming events to partner APIs via actions.

The definition of a Destination may look something like this, and should be the default export from a destinations/<destination>/index.ts:

```
const destination: DestinationDefinition = {
  // The human-readable name of the destination
  name: ′Your Destination Name′,
  // The authentication scheme and fields
  authentication: { },
  // Extends the instance of the ′fetch′ client with request options
  extendRequest: ({ settings }) => { },
  // See ″Actions″ section below
  actions: { }
}
```

extendRequest(function(Data))

extendRequest( ) adds a callback function that can set default fetch request options for all requests made by actions registered with this destination. It returns the base destination object.

```
const destination: DestinationDefinition = {
  name: ′Authorization Header Example′,
  extendRequest({ settings }) {
    return {
      headers: {
        Authorization: ′Bearer ${settings.apiKey}′
      }
    }
  }
}
```

Action Definition

Actions are the discrete units that represent an interaction with the partner API. An action is composed of a sequence of steps that are created based on the definition, like mapping the event to a payload defined in the action, validating that payload, and performing the action (aka talking to the partner API). Actions may look like this.

```
const action: ActionDefinition = {
  // The action-specific fields that can be configured by the customer
  // Ideally these fields will match what the partner API expects
  fields: { },
  // The set of fields that support UI-triggered interaction with the
partner API to fetch choices (using the authenticated account)
  // For example: fetching a list of Slack channels the user can select
  dynamicFields: { }
  // The operation that an action performs when executed to send the
mapped payload to the partner API
  // This is the core function of an action.
  perform: (request, data) => { }
}
```

perform

perform( ) accepts a callback function that receives a fetch-based request client and the Data object and returns the value that should be associated with the key.

```
const action = {
  // ....
  perform: (request, { payload, settings }) => {
    return request(′http://example.com/users/${payload.userId}′, {
      method: ′put′,
      headers: {
        Authorization: ′Bearer ${settings.apiKey}′
      },
      json: payload.userProperties
    })
  }
}
```

The Data Object

The Data object is an object passed to many of the callbacks that developers may define when adding steps to an Action object. The Data object is used to propagate the incoming payload, settings, and other values created at runtime among the various steps:

Field Type Description

payload object Incoming system event-mapped payload.

settings object Top-level destination setting values. E.g., apiKey

Get started

Local development

This is a monorepo with multiple packages leveraging lerna with Yarn Workspaces:

packages/ajv-human-errors—a wrapper around AJV errors to produce more friendly validation messages

packages/browser-destinations—destination definitions that run on device via Analytics 2.0

packages/cli—a set of command line tools for interacting with the repo

packages/core—the core runtime engine for actions, including mapping-kit transforms

packages/destinations-actions—destination definitions and their actions

packages/destinations-subscriptions—validates events against an action's subscription AST

Getting set up

Developers may need to have some tools installed locally to build and test action destinations.

Yarn 1.x

Node 14.17 (latest LTS, we recommend using nvm for managing Node versions)

Developers may want to fork this repository for their organization to submit Pull Requests against the main system repository. Once developers have got a fork, they can git clone that locally.

```
  # Clone the repo locally
  git clone <your fork or https://github.com/segmentio/action-
destinations.git>
  cd action-destinations
  npm login
  yarn login
  # Requires node 14.17, optionally: nvm use 14.17
  yarn --ignore-optional
  yarn bootstrap
  yarn build
  yarn install
  # Run unit tests to ensure things are working! All tests should pass :)
  yarn test
```

Actions CLI

In order to run the CLI (./bin/run), the current working directory needs to be the root of the action-destinations repository.

# see what′s supported by the CLI
./bin/run --help
# scaffold a new destination
./bin/run init
# scaffold a new action within a destination
./bin/run generate:action <ACTION_NAME> <browser|server>
# generates TypeScript definitions for an integration
./bin/run generate:types
# start local development server
./bin/run serve

Troubleshooting CLI

If a CLI command fails to work properly, run the command with DEBUG=* at the beginning (e.g. DEBUG=*./bin/run serve). This may produce a verbose debugging output, providing hints as to why something isn't working as expected. All of the CLI commands are also in the ./packages/cli/src/commands directory if developers need to inspect them further.

Debugging

Pass the Node flag --inspect when the local server is run, and then a debugger may be attached from an IDE. The serve command may pass any extra args/flags to the underlying Node process.

Configuring

Action destinations are configured using a single Destination setting (subscriptions) that should contain a JSON blob of all subscriptions for the destination. The format should look like this:

```
[
  {
    ″subscribe″: ″<fql query>″,
    ″partnerAction″: ″<actionSlug>″,
    // See ./packages/core/src/mapping-kit/README.md for
documentation. The keys in this object should match the ′action.fields′
    ″mapping″: { ... }
  }
]
Here′s a full example:
[
  {
    ″subscribe″: ″type = ′track′″,
    ″partnerAction″: ″postToChannel″,
    ″mapping″: {
      ″text″: {
        ″@template″: ″Tracked! event= , ″
      },
      ″url″:
″https://hooks.slack.com/services/0HL7TC62R/0T276CRHL/
8WvI6gEiE9ZqD47kWqYbfIhZ″,
      ″channel″: ″test-channel″
    }
  },
  {
    ″subscribe″: ″type = ′identify′″,
    ″partnerAction″: ″postToChannel″,
    ″mapping″: {
      ″text″: {
        ″@template″: ″User identified! email= ″
      },
      ″url″:
″https://hooks.slack.com/services/0HL7TC62R/0T276CRHL/
8WvI6gEiE9ZqD47kWqYbfIhZ″,
      ″channel″: ″test-channel″
    }
  }
]
```

Example Destination

Local File Structure

In the destination's folder, this general structure should be seen. The index.ts file (with the asterisk) is the entry point to the destination—the CLI expects a destination definition to be exported from there.

$ tree packages/destination-actions/src/destinations/slack
packages/destination-actions/src/destinations/slack

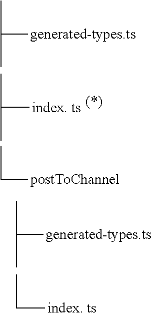

Local Destination Definition

The main definition of your Destination may look something like this, and is what your index.ts should export as the default export:

```
  const destination = {
    name: ′Example Destination′,
    // a human-friendly description that gets displayed to users. supports
  markdown
    description: ″
    // see ″ Authentication″ section below
    authentication: { }
    // see ″HTTP Requests″ section below
    extendRequest: ( ) => { }
    // see ″Actions″ section below
    actions: { }
  }
```

export default destination

Input Fields

For each action or authentication scheme developers can define a collection of inputs as fields. Input fields are what users see in the Action Editor to configure how data gets sent to the destination or what data is needed for authentication. These fields (for the action only) are able to accept input from the system event.

Input fields have various properties that help define how they are rendered, how their values are parsed and more. Here's an example:

```
const destination = {
  // ...other properties
  actions: {
    postToChannel: {
      / ...
      fields: {
        webhookUrl: {
          label: ′Webhook URL′,
          description: ′Slack webhook URL.′,
          type: ′string′,
          required: true
        },
        text: {
          label: ′Message′,
          description: ′The text message to post to Slack′,
          type: ′string′,
          required: true
        }
      }
    }
  }
}
```

Input Field Interface

Here's the full interface that input fields allow:

```
  interface InputField {
    /** A short, human-friendly label for the field */
    label: string
    /** A human-friendly description of the field */
    description: string
    /** The data type for the field */
    type: ′string′ | ′text′ | ′number′ | ′integer′ | ′datetime′ | ′boolean′ |
′password′ | ′object′
    /** Whether null is allowed or not */
    allowNull?: boolean
    /** Whether or not the field accepts multiple values (an array of
′type′) */
    multiple?: boolean
    /** An optional default value for the field */
    default?: string | number | boolean | object | Directive
    /** A placeholder display value that suggests what to input */
    placeholder?: string
    /** Whether or not the field supports dynamically fetching options
*/
    dynamic?: boolean
    /** Whether or not the field is required */
    required?: boolean
    /**
      Optional definition for the properties of ′type: ′object′′ fields
      * (also arrays of objects when using ′multiple: true′)
      * Note: this part of the schema is not persisted outside the code
      * but is used for validation and typedefs
      */
    properties?: Record<string, InputField>
    /**
      * Format option to specify more nuanced ′string′ types
      * @see {@link https://github.com/ajv-
validator/ajv/trec/v6#formats}
      */
      format?:
        | ′date′ // full-date according to RFC3339.
        | ′time′ // time with optional time-zone.
        | ′date-time′ // date-time from the same source (time-zone is
mandatory). date, time and date-time validate ranges in full mode and only
regexp in fast mode (see options).
        | ′uri′ // full URI.
        | ′uri-reference′ // URI reference, including full and relative
URIs.
        | ′uri-template′ // URI template according to RFC6570
        | ′email′ // email address.
        | ′hostname′ // host name according to RFC1034.
        | ′ipv4′ // IP address v4.
        | ′ipv6′ // IP address v6.
        | ′regex′ // tests whether a string is a valid regular expression by
passing it to RegExp constructor.
        | ′uuid′ // Universally Unique IDentifier according to RFC4122.
        | ′password′ // hint to the UI to hide/obfuscate input strings
(applied automatically when using type: ′password′′
        | ′text′ // longer strings (applied automatically when using ′type:
′text′′
  }
```

Default Values

Developers can set default values for fields. These defaults are not used at run-time, however. These defaults pre-populate the initial value of the field when users first set up an action.

Default values can be literal values that match the type of the field (e.g. a literal string: ““hello””) or they can be mapping-kit directives just like the values from the system's rich input in the app. It's likely that developers may want to use directives to the default value. Here are some examples:

```
const destination =
  // ...other properties
  actions: {
    doSomething: {
      // ...
      fields: {
        name: {
          label: ′Name′,
          description: ′The person\′s name′,
          type: ′string′,
          default: { ′@path′: ′$.traits.name′ },
          required: true
        },
        email: {
          label: ′Email′,
          description: ′The person\′s email address′,
          type: ′string′,
          default: { ′@path′: ′$.properties.email_address′ }
        }
      }
    }
  }
}
```

In addition to default values for input fields, developers can also specify the defaultSubscription for a given action—this is the FQL query that may be automatically populated when a customer configures a new subscription triggering a given action.

The perform function

The perform function defines what the action actually does. All logic and request handling happens here. Every action MUST have a perform function defined.

By the time the actions runtime invokes the action's perform, payloads have already been resolved based on the customer's configuration, validated against the schema, and can be expected to match the types provided in the perform function. Developers may get compile-time type-safety for how they access anything in the data.payload (the 2nd argument of the perform).

A basic example:

```
const destination = {
  actions: {
    someAction: {
      // ...
      fields: {
        greeting: {
          label: ′Greeting′,
          description: ′The text message to send′,
          type: ′string′,
          required: true
        }
      },
      // ′perform′ takes two arguments:
      // 1. the request client instance (extended with the destination′s
′extendRequest′
      // 2. the data bundle which includes ′settings′ for top-level
authentication fields and the ′payload′ which contains all the validated,
resolved fields expected by the action
        perform: (request, data) => {
        return request(′https://example.com′, {
          headers: { Authorization: ′Bearer ${data.settings.api_key}′ },
          json: data.payload
        })
      }
    }
  }
}
```

The perform method may be invoked once for every event subscription that triggers the action. If developers need to support batching, the system provides a performBatch function.

Batching Requests

Sometimes customers have a lot of events, and the developer's API supports a more efficient way to receive and process those large sets of data.

In this case, developers can implement an additional perform method named performBatch in the action definition, alongside the perform method. The method signature looks like identical to perform except the payload is an array of data, where each item is an object matching the action's field schema:

```
  function performBatch(request, { settings, payload }) {
    return request(′https://example.com/batch′, {
      //′payload′ is an array of objects, each matching the action′s field
definition
      json: payload
    })
)
```

This may give customers the ability to opt-in to batching (there may be trade-offs they need to consider before opting in). Each customer subscription may be given the ability to Enable Batching.

Keep in mind a few important things about how batching works:

Batching can add latency while the system accumulates events in batches internally. This can be up to a minute, currently, but this is subject to change at any time. Latency is lower when a higher volume of events is sent.

Batches may have to up 1,000 events, currently. This, too, is subject to change.

Batch sizes are not guaranteed. Due to the way that batches are accumulated internally, developers may see smaller batch sizes than they expect when sending low rates of events.

HTTP Requests

Developers can use the request object to make requests and curate responses. This request is injected as the first argument in all operation functions in the definition (for example, in an action's perform function).

In addition to making manual HTTP requests, developers can use the extendRequest helper to reduce boilerplate across actions and authentication operations in the definition:

```
const destination = {
  // ...other properties
  extendRequest: (request, { settings }) => {
    return {
      headers: { Authorization: ″Bearer ${settings.apiKey}′ }
    }
  },
  actions: {
    doAThing: {
      // ...other properties
      perform: (request, data) => {
        // this request will have the Authorization header
        return request(′https://example.com/api/me.json′, {
          method: ′post′,
          json: data
        })
      }
    }
  }
}
```

HTTP Request Options

The request client is a thin wrapper around the Fetch API, made available both in Node (via node-fetch) and in the browser (with the whatwg-fetch ponyfill as needed).

Both the request(url, options) function and the extendRequest return value also support all of the Fetch API and some additional options:

```
  method: HTTP method, default is GET.
  headers: HTTP request headers object as a plain object { foo: 1, bar:
true }.
  json: shortcut to automatically JSON.stringify into the request body
and set the content-type header to application/json.
  password: Basic authentication password field. Will automatically
get base64 encoded with the username and added to the request headers:
Authorization: Basic <username:password
  searchParams: URLSearchParams or a plain object that developers
want included in request url′s query string.
  throwHttpErrors: whether or not the request should throw an
HTTPError for non-2xx responses. Default is true.
  timeout: Time in milliseconds when a request should be aborted.
Default is 10000.
  username: Basic authentication username field. Will automatically
get base64 encoded with the password and added to the request headers:
Authorization: Basic <username:password>
  const response = await request(′https://example.com′, {
    method: ′post′,
    headers: { ′content-type′: ′application/json′ },
    json: { hello: ′world′ },
    searchParams: { foo: 1, bar: true },
    username: ′my′,
    password: ′secret′,
    timeout: 10000,
    throwHttpErrors: true
  })
```

### Example Mobile Device

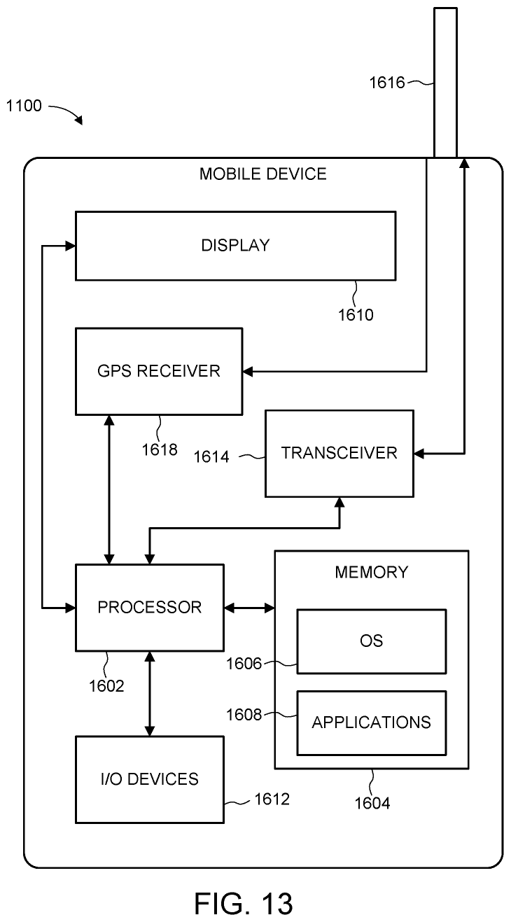

FIG. 13 is a block diagram illustrating a mobile device 1100, according to an example embodiment.

The mobile device 1100 can include a processor 1602. The processor 1602 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1100. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

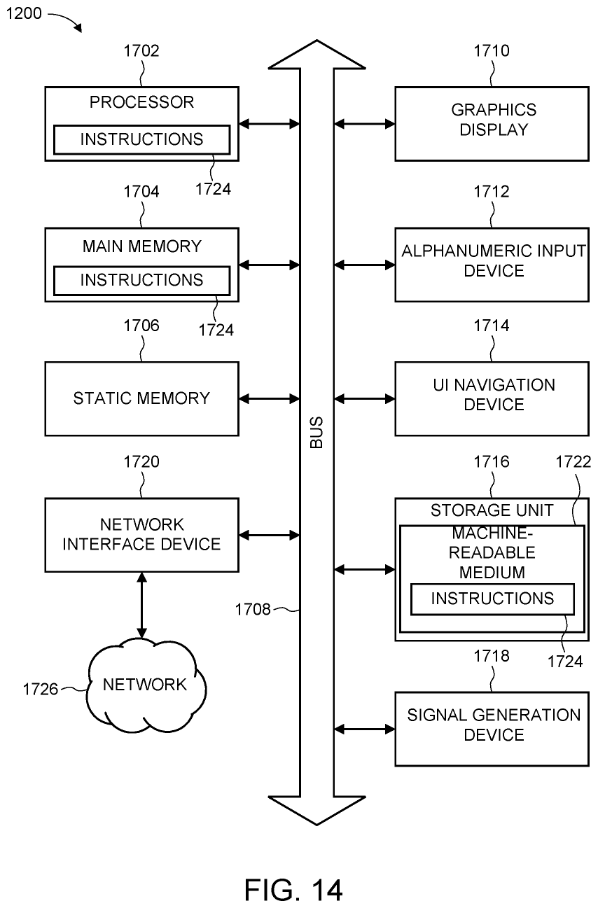

FIG. 14 is a block diagram of an example computer system 1200 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1702 (e.g., a central processing unit (CPU), a graphics processing unit (GPU) or both), a main memory 1704 and a static memory 1706, which communicate with each other via a bus 1708. The computer system 1200 may further include a graphics display unit 1710 (e.g., a liquid crystal display (LCD) or a cathode ray tube (CRT)). The computer system 1200 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1200, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving a definition of a destination via an API, the definition including a definition of an action, the definition of the action representing an interaction with an API associated with the destination, the definition of the action including one or more definitions of one or more input fields associated with the action;
surfacing the action in a user interface, the surfacing including presenting a graphical representation of the one or more input fields based on the one or more definitions of the one or more input fields;
receiving one or more inputs via the graphical representation of the one or more input fields; and
routing event data from one or more data sources to the destination, the routing including mapping the event data to the destination based on the one or more inputs.

2. The system of claim 1, wherein the definition of the action includes one or more definitions of one or more steps associated with the action.

3. The system of claim 2, wherein each of the one or more steps is passed a data object that propagates an incoming payload or settings across the one or more steps.

4. The system of claim 1, wherein the one or more steps include a performance step.

5. The system of claim 4, wherein the performance step is invoked after a payload has been resolved based on a configuration associated with the destination.

6. The system of claim 4, wherein the performance step is invoked after a payload has been validated against a data schema associated with the destination.

7. The system of claim 1, wherein the definition is developed according to a recommended structure.

8. A method comprising:
receiving a definition of a destination via an API, the definition including a definition of an action, the definition of the action representing an interaction with an API associated with the destination, the definition of the action including one or more definitions of one or more input fields associated with the action;
surfacing the action in a user interface, the surfacing including presenting a graphical representation of the one or more input fields based on the one or more definitions of the one or more input fields;
receiving one or more inputs via the graphical representation of the one or more input fields; and
routing event data from one or more data sources to the destination, the routing including mapping the event data to the destination based on the one or more inputs.

9. The method of claim 8, wherein the definition of the action includes one or more definitions of one or more steps associated with the action.

10. The method of claim 9, wherein each of the one or more steps is passed a data object that propagates an incoming payload or settings across the one or more steps.

11. The method of claim 8, wherein the one or more steps include a performance step.

12. The method of claim 11, wherein the performance step is invoked after a payload has been resolved based on a configuration associated with the destination.

13. The method of claim 11, wherein the performance step is invoked after a payload has been validated against a data schema associated with the destination.

14. The method stem of claim 8, wherein the definition is developed according to a recommended structure.

15. A non-transitory computer-readable storage medium storing a set of instructions that, when executed by one or more computer processors, causes the one or more computer processors to perform operations, the operations comprising:
receiving a definition of a destination via an API, the definition including a definition of an action, the definition of the action representing an interaction with an API associated with the destination, the definition of the action including one or more definitions of one or more input fields associated with the action;
surfacing the action in a user interface, the surfacing including presenting a graphical representation of the one or more input fields based on the one or more definitions of the one or more input fields;
receiving one or more inputs via the graphical representation of the one or more input fields; and
routing event data from one or more data sources to the destination, the routing including mapping the event data to the destination based on the one or more inputs.

16. The non-transitory computer-readable storage medium of claim 15, wherein the definition of the action includes one or more definitions of one or more steps associated with the action.

17. The non-transitory computer-readable storage medium of claim 16, wherein each of the one or more steps is passed a data object that propagates an incoming payload or settings across the one or more steps.

18. The non-transitory computer-readable storage medium of claim 15, wherein the one or more steps include a performance step.

19. The non-transitory computer-readable storage medium of claim 18, wherein the performance step is invoked after a payload has been resolved based on a configuration associated with the destination.

20. The non-transitory computer-readable storage medium of claim 18, wherein the performance step is invoked after a payload has been validated against a data schema associated with the destination.
